(19) United States
(12) Patent Application Publication
(10) Pub. No.: US 2018/0189894 A1
(43) Pub. Date: Jul. 5, 2018

(54) MOBILE TERMINAL AND METHOD FOR CONTROLLING THE SAME

(71) Applicant: LG ELECTRONICS INC., Seoul (KR)

(72) Inventors: Jipyo HONG, Seoul (KR); Yoojin CHOI, Seoul (KR); Jongsup KIM, Seoul (KR); Goeun JOO, Seoul (KR); Daejin KONG, Seoul (KR); Seungman YANG, Seoul (KR); Seonghui KIM, Seoul (KR); Seongmin HWANG, Seoul (KR)

(73) Assignee: LG ELECTRONICS INC., Seoul (KR)

(21) Appl. No.: 15/739,552

(22) PCT Filed: Mar. 14, 2016
(86) PCT No.: PCT/KR2016/002531

§ 371 Date: Dec. 22, 2017

(30) Foreign Application Priority Data
Jun. 22, 2015 (KR) 10-2015-0088380

(51) Int. Cl. G06Q 50/00; H04W 4/21; H04W 4/08; H04W 8/18; H04M 1/725

(52) U.S. Cl. CPC G06Q 50/01; H04W 4/21; H04M 1/72522; H04W 8/18; H04W 4/08

(57) ABSTRACT

The present invention relates to a method for controlling a mobile terminal, which comprises the steps of: sending a request for starting of a group concierge service to a concierge server; receiving, from the concierge server, information on other terminal users having the same interest as a user of the mobile terminal; and displaying information which proposes generation of a group with the other terminal users. The present invention provides a mobile terminal and a method for controlling the same, which identify terminal users having the same interest as a user of the mobile terminal himself/herself and then propose group generation, continuously identify information on terminal users belonging to a particular group and then provide information relating to the group members' interests, and propose a group activity or a group meeting.

### TECHNICAL FIELD

The present invention relates to a mobile terminal and a method for controlling the same, and more particularly, to a mobile terminal that identifies terminal users having the same interest as a user of the mobile terminal and proposes group generation and a group activity, and a method for controlling the same.

### BACKGROUND ART

Terminals may be divided into mobile/portable terminals and stationary terminals depending on their mobility. Mobile/portable terminals may be subdivided into handheld terminals and vehicle-mounted terminals depending on whether or not users can carry their terminals with them.

The features of the mobile terminals are becoming diversified. These features include data and voice communication, taking photos and videos with a camera, voice recording, playing music files through a speaker system, and outputting images or videos to a display, for example. Some phones have a game play feature added to it, or offer a multimedia player feature. Notably, recent mobile terminals can receive multicast signals to provide visual content, such as broadcasts, videos, or television programs.

As the features of terminals have become diversified, they are implemented in the form of a multimedia player with combined features like taking photos or videos, playing music or video files, gaming, receiving broadcasts, etc. To support and enhance these features of terminals, structural and/or software parts of the terminals may need improvements.

Meanwhile, recent mobile terminals come with a concierge feature which provides customized notifications based on each users information, life patterns, inclinations, etc. As for weather, for instance, a user who likes basketball may get an optimized notification saying, “Why don't you enjoy this lovely weather playing a basketball game at a park?”.

However, such a concierge feature is only applicable to individual mobile terminals at the moment but does not cover groups of mobile terminals. Accordingly, there is a need to provide a group concierge feature which generates a group, continuously identifies group members' information, life patterns, inclinations, etc. and suggests a group activity, and suggests the group members' activities, hobbies, etc. to them.

### DISCLOSURE

### Technical Problem

An object of the present invention is to solve the foregoing and other problems. Another object is to provide a mobile terminal that identifies terminal users having the same interest as a user of the mobile terminal and proposes group generation, and a method for controlling the same.

Still another object is to provide a mobile terminal that continuously identifies information on terminal users belonging to a particular group and provides information relating to the group members' interests, and then proposes a group activity or a group meeting.

### Technical Solution

According to an aspect of the present invention to achieve the above or other objects, there is provided a method for controlling a mobile terminal, the method including the steps of: sending a request for starting of a group concierge service to a concierge server; receiving, from the concierge server, information on other terminal users having the same interest as a user of the mobile terminal; and displaying information which proposes generation of a group with the other terminal users.

According to another aspect of the present invention, there is provided a mobile terminal including: a display unit; a wireless communication unit that performs wireless communication with a concierge server; and a control unit that, upon a group concierge service request, receives information on other terminal users having the same interest as a user of the mobile terminal from the concierge server and displays on the display unit information proposing generation of a group with the other terminal users.

### Advantageous Effects

The effects of a mobile terminal and a method for controlling the same according to the present invention are as follows:

According to at least one of the embodiments of the present invention, user convenience distinct from those provided by conventional mobile terminals can be provided by proposing group generation by identifying other terminal users having the same interests as a user of the mobile terminal.

Furthermore, according to at least one of the embodiments of the present invention, user convenience distinct from those provided by conventional mobile terminals can be provided by proposing a group activity or a group meeting by continuously identifying information on terminal users belonging to a particular group and their life patterns, inclinations, etc.

Meanwhile, other various effects will be disclosed explicitly or implicitly in the following detailed description of the embodiments of the present invention.

### DESCRIPTION OF DRAWINGS

FIG. 1A is a block diagram illustrating a mobile terminal related to the present invention:

FIGS. 1B and 1C are conceptual diagrams of an example of a mobile terminal related to the present invention, as viewed from different directions;

FIG. 2 is a schematic view of a configuration of a communication system that provides a concierge server according to the present invention;

FIG. 3 is a process flowchart illustrating an operation in which a group concierge service is provided in a communication system according to an exemplary embodiment of the present invention:

FIG. 4 is a view used as a reference to explain a mobile terminal's operation for identifying people with the same interests as the user among the user's acquaintances and suggesting group creation;

FIG. 5 is a view used as a reference to explain a mobile terminal's operation for identifying anonymous people with the same interests as the user among the user's acquaintances through collective intelligence and suggesting group creation;

FIGS. 6 to 11 are views used as a reference to explain various methods of suggesting group creation by neighboring device recognition;

FIG. 12 is a view used as a reference to explain a mobile terminal's operation for suggesting group creation based on a short-range sensor and address book information;

FIG. 13 is a view used as a reference to explain a mobile terminal's operation for suggesting group creation based on location and time information of a neighboring device:

FIG. 14 is a view used as a reference to explain a mobile terminal's operation for suggesting group creation via an AP (access point);

FIGS. 15 and 16 are views used as a reference to explain a mobile terminal's operation for suggesting group creation via a hotspot;

FIGS. 17 to 22 are views used as a reference to explain various methods for suggesting group creation based on app information;

FIGS. 23 to 31 are views used as a reference to explain a mobile terminal's operation for providing information about a group's common interests and suggesting a group activity or a group meeting;

FIG. 32 is a view used as a reference to explain a mobile terminal's operation for suggesting other group members' interests.

FIG. 33 is a view used as a reference to explain a mobile terminal's operation for sharing interest information provided from the concierge server with other group members:

FIG. 34 is a view used as a reference to explain a mobile terminal's operation for suggesting to share their location and photos; and

FIGS. 35 to 38 are views used as a reference to explain a mobile terminal's operations for providing services such as reproducing collective intelligence and automatically sharing intelligence.

### MODE FOR INVENTION

Hereinafter, embodiments of the present invention are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and, do not have distinctive meanings or roles by themselves. Additionally, the accompanying drawings are used to help easily understanding embodiments disclosed herein but the technical idea of the present invention is not limited thereto. It should be understood that all of variations, equivalents or substitutes contained in the concept and technical scope of the present invention are also included.

Mobile terminals described in this specification may include mobile phones, smartphones, laptop computers, terminals for digital broadcast, personal digital assistants (PDAs), portable multimedia players (PMPs), navigation systems, slate PCs, tablet PCs, ultrabooks, and wearable devices (for example, smart watches, smart glasses, and head mounted displays (HMDs)).

However, it is apparent to those skilled in the art that configurations according to embodiments of the present invention disclosed in this specification are applicable to stationary terminals such as digital TVs, desktop computers, and digital signage, except for the case applicable to only mobile terminals.

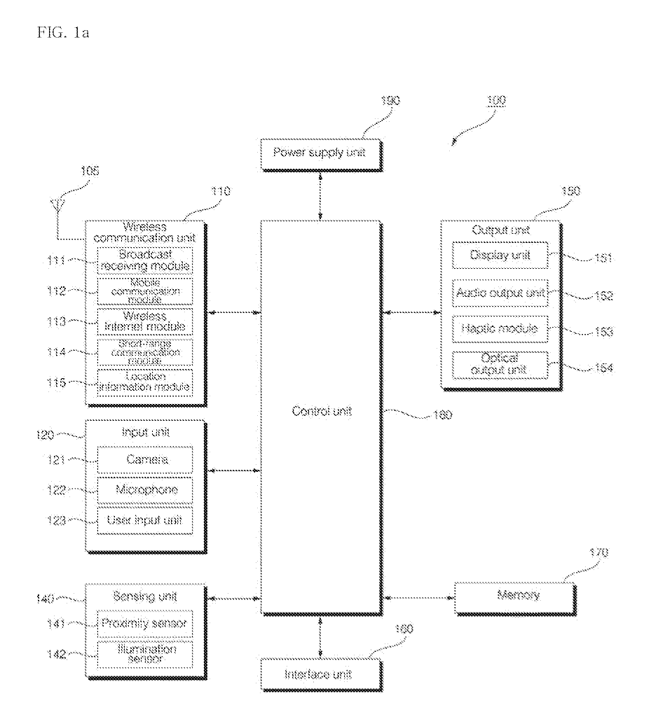

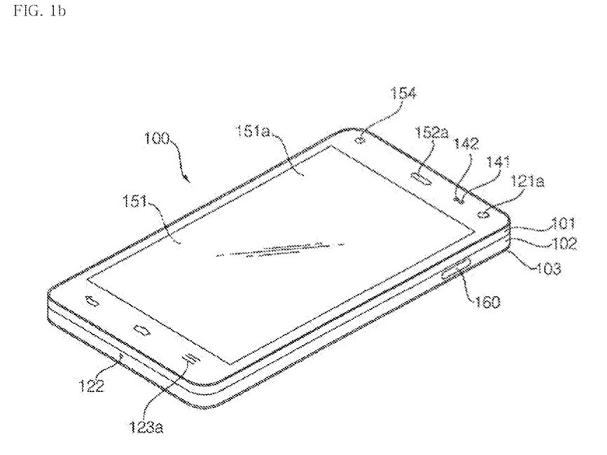

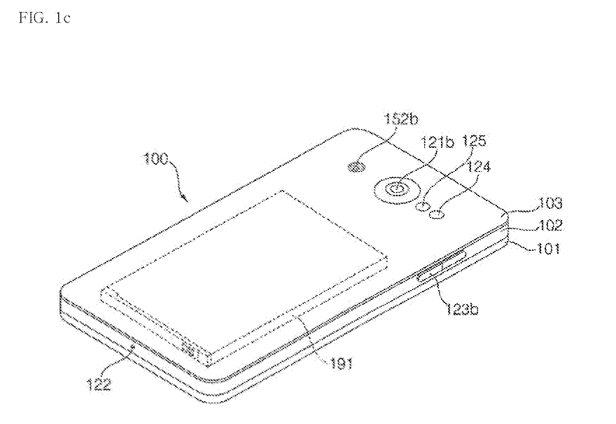

Referring to FIGS. 1A and 1C, FIG. 1A is a block diagram illustrating a mobile terminal related to the present invention. FIGS. 1B and 1C are conceptual diagrams of an example of a mobile terminal related to the present invention, as viewed from different directions.

The mobile terminal 100 may include a wireless communication unit 110, an input unit 120, a sensing unit 140, an output unit 150, an interface unit 160, a memory 170, a control unit 180, and a power supply unit 190. In implementing a mobile terminal, components shown in FIG. 1 are not necessary, so that a mobile terminal described in this specification may include components less or more than the components listed above.

Specifically, the wireless communication unit 110, among the above components may include one or more modules that allow wireless communication between the mobile terminal 100 and a wireless communication system, between the mobile terminal 100 and another mobile terminal 100, or between the mobile terminal 100 and an external server. Additionally, the wireless communication unit 110 may include one or more modules that connect the mobile terminal 100 to one or more networks.

The wireless communication unit 110 may include at least one among a broadcast receiving module 111, a mobile communication module 112, a wireless Internet module 113, a short-range communication module 114, and a location information module 115.

The input unit 120 may include a camera 121 or an image input unit for image signal input, a microphone 122 or an audio input unit for receiving audio signal input, and a user input unit 123 (for example, a touch key and a mechanical key)) for receiving information from a user. Voice data or image data collected by the input unit 120 are analyzed and processed as a user's control command.

The sensing unit 140 may include at least one sensor for sensing at least one among information in the mobile terminal, environmental information around the mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, the camera 121), a microphone (for example, the microphone 122), a battery gauge, an environmental sensor (for example, a barometer, a hygrometer, a thermometer, a radiation sensor, a thermal sensor, and a gas sensor), and a chemical sensor (for example, an electronic noise, a healthcare sensor, and a biometric sensor). Moreover, a mobile terminal disclosed in this specification may combine information sensed by at least two or more sensors among such sensors and may then utilize it.

The output unit 150 is used to generate a visual, auditory, or haptic output and may include at least one among a display unit 151, a sound output unit 152, a haptic module 153, and an optical output unit 154. The display unit 151 may implement a touchscreen by forming an interlayer structure together with a touch sensor or being integrated with the touch sensor. Such a touch screen may serve as the user input unit 123 providing an input interface between the mobile terminal 100 and a user and at the same time as an output interface between the mobile terminal 100 and a user.

The interface unit 160 may serve as a path to various kinds of external devices connected to the mobile terminal 100. The interface unit 160 may include at least one among a wired/wireless headset port, an external charger port, a wired/wireless data port, a memory card port, a port connecting a device equipped with an identification module, an audio input/output (I/O) port, a video I/O port, and an earphone port. To cope with an external device's connection to the interface unit 160, the mobile terminal 100 may perform an appropriate control relating to the connected external device.

Moreover, the memory 170 may store data supporting various functions of the mobile terminal 100. The memory 170 may store a plurality of application programs (or applications) running on the mobile terminal 100 and also data and commands for operation of the mobile terminal 100. At least some of these application program may be downloaded from an external server through wireless communication. Also, at least some of these application programs may be included in the mobile terminal 100 at the time of shipment in order to perform basic functions (e.g., sending and receiving calls and sending and receiving messages) of the mobile terminal 100. Moreover, an application program may be stored in the memory 170 and installed on the mobile terminal 100, so that it may be run to perform an operation (or function) of the mobile terminal 100 by the control unit 180.

The control unit 180, in general, control overall operations of the mobile terminal 100, besides operations relating to the application program. The control unit 180 may provide appropriate information or functions to a user or process them by processing signals, data, and information input/output through the above components or executing the application programs stored in the memory 170

Additionally, in order to execute an application program stored in the memory 170, the control unit 180 may control at least part of the components shown in FIG. 1. Furthermore, in order to execute the application program, the control unit 180 may operate at least two of the components in the mobile terminal 100 in combination.

The power supply unit 190 may receive external power or internal power under control of the control unit 180 and then supply power to each component in the mobile terminal 100. The power supply unit 190 includes a battery, and the battery may be a built-in battery or a replaceable battery.

At least part of the above components may operate in cooperation in order to implement the operation, control, or control method of a mobile terminal according to various embodiments of the present invention described below. Also, the operation, control, or control method of a mobile terminal 100 may be implemented on the mobile terminal 100 by executing at least one application program stored in the memory 170.

Hereinafter, prior to examining various embodiments implemented through the above mobile terminal 100, the above-listed components will be described in more detail with reference to FIG. 1A.

First of all, in describing the wireless communication unit 110, the broadcast receiving module 111 of the wireless communication unit 110 may receive a broadcast signal and/or broadcast-related information from an external broadcast management server through a broadcast channel. The broadcast channel may include a satellite channel and a terrestrial channel. At least two broadcast receiving modules for simultaneous broadcast reception for at least two broadcast channels or broadcast channel switching may be provided to the mobile terminal 100.

The mobile communication module 112 may transmit/receive a wireless signal to/from at least one among a base station, an external terminal, and a server on a mobile communication network established according to the technical standards or communication schemes for mobile communication (for example, Global System for Mobile communication (GSM). Code Division Multi Access (CDMA), Code Division Multi Access 2000 (CDMA2000). Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless signal may include a voice call signal, a video call signal, or various types of data of a sent or received text/multimedia message.

The wireless internet module 113 refers to a module for wireless internet access and may be built in or external to the mobile terminal 100. The wireless internet module 113 may be configured to transmit/receive a wireless signal in a communication network according to wireless internet technologies.

The wireless internet technologies may include Wireless LAN (WLAN), Wireless-Fidelity (Wi-Fi). Wi-Fi Direct, Digital Living Network Alliance (DLNA). Wireless Broadband (WiBro). World Interoperability for Microwave Access (WiMAX), High Speed Downlink Packet Access (HSDPA), High Speed Uplink Packet Access (HSUPA). Long Term Evolution (LTE), and Long Term Evolution-Advanced (LTE-A) and the wireless internet module 113 transmits/receives data according at least one wireless internet technology including internet technologies not listed above.

From the viewpoint that wireless internet access by WiBro, HSDPA, HSUPA, GSM, CDMA, WCDMA, LTE, and LTE-A is achieved through a mobile communication network, the wireless internet module 113 performing wireless internet access through the mobile communication network may be understood as one type of the mobile communication module 112.

The short-range communication module 114 may support short-range communication by using at least one among Bluetooth™, Radio Frequency Identification (RFID), Infrared Data Association (IrDA), Ultra Wideband (UWB). ZigBee, Near Field Communication (NFC). Wireless-Fidelity (Wi-Fi), Wi-Fi Direct, and Wireless Universal Serial Bus (USB) technologies. The short-range communication module 114 may support wireless communication between the mobile terminal 100 and a wireless communication system, between the mobile terminal 100 and another mobile terminal 100, or between the mobile terminal 100 and a network in which another mobile terminal 100 (or external server) is located, through a wireless area network. The wireless area network may be a wireless personal area network.

Here, the other mobile terminal 100 may be a wearable device (for example, a smart watch, a smart glass, and an HMD) that is capable of exchanging data (or interworking) with the mobile terminal 100 according to the present invention. The short-range communication module 114 may detect (or recognize) a wearable device capable of communicating with the mobile terminal 100 around the mobile terminal 100. Furthermore, if the detected wearable device is a device authenticated to communicate with the mobile terminal 100 according to the present invention, the control unit 180 may transmit at least part of data processed in the mobile terminal 100 to the wearable device through the short-range communication module 114. Accordingly, the user of the wearable device may use the data processed in the mobile terminal 100 through the wearable device. For example, when a call is received by the mobile terminal 100, the user may have a phone conversation through the wearable device or when a message is received by the mobile terminal 100, the user may check the received message through the wearable device.

The location information module 115 is a module for obtaining the location (or current location) of the mobile terminal, and its representative examples include a global positioning system (GPS) module or a Wi-Fi module. For example, using the GPS module, the mobile terminal may obtain its location by a signal sent from a GPS satellite. As another example, using the Wi-Fi module, the mobile terminal may obtain its location based on information of a wireless access point (AP) transmitting/receiving a wireless signal to/from the Wi-Fi module. If necessary, the location information module 115 may perform a function of another module in the wireless communication unit 110, in order to obtain data on the location (or current location) of the mobile terminal as a replacement or addition. The location information module 115 is a module for obtaining the location (or current position) of the mobile terminal, and is not limited to a module that directly calculates or obtains the location of the mobile terminal.

Then, the input unit 120 is used for inputting image information (or signal), audio information (or signal), data, or information input from the user, and the mobile terminal 100 may include at least one camera 121 in order to input image information. The camera 121 processes image frames of a still image or video obtained by an image sensor in a video call mode or a capture mode. The processed image frames may be displayed on the display unit 151 or stored in the memory 170. Moreover, a plurality of cameras 121 equipped in the mobile terminal 100 may be arranged in a matrix structure. Using the camera 121 having a matrix structure, a plurality of pieces of image information having various angles or focuses may be input to the mobile terminal 100. Additionally, the plurality of cameras 121 may be arranged in a stereo structure to obtain left and right images for implementing a three-dimensional image.

The microphone 122 processes external audio signals into electrical voice data. The processed voice data may be used variously according to a function executed (or application program running) on the mobile terminal 100. Moreover, various noise canceling algorithms for removing noise occurring during the reception of external audio signals may be implemented in the microphone 122.

The user input unit 123 is for receiving information from the user, and when information is input through the user input unit 123, the control unit 180 may control the operation of the mobile terminal 100 to correspond to the input information. The user input unit 123 may include a mechanical input means (or a mechanical key, for example, a button positioned at the front or rear surface or the side surface of the mobile terminal 100, a dome switch, a jog wheel, or a jog switch) and a touch type input means. As one example, the touch type input means may include a virtual key, a soft key, or a visual key, which is displayed on a touch screen through software processing, or may include a touch key disposed at a portion other than the touch screen. Moreover, the virtual key or visual key may be displayed on a touch screen in various forms, and may include, for example, graphics, text, icon, video, or a combination thereof.

Meanwhile, the sensing unit 140 may sense at least one among information in the mobile terminal, environmental information around the mobile terminal, and user information, and may then generate a corresponding sensing signal. Based on such a sensing signal, the control unit 180 may control the operation or control of the mobile terminal 100 or perform data processing, functions, or operations relating to an application program installed in the mobile terminal 100. Representative examples of various sensors that may be included in the sensing unit 140 will be described in more detail.

First of all, the proximity sensor 141 refers to a sensor that detects the presence or absence of an object approaching a predetermined detection surface or the presence or absence of an object nearby by using the intensity of an electromagnetic field or infrared rays, without mechanical contact. The proximity sensor 141 may be disposed in an inner area of the mobile terminal surrounded by the above-mentioned touch screen or near the touch screen.

Examples of the proximity sensor 141 may include a transmission-type photoelectric sensor, a direct reflective photoelectric sensor, a mirror reflective photoelectric sensor, a high-frequency oscillatory proximity sensor, a capacitive proximity sensor, a magnetic proximity sensor, and an infrared proximity sensor. If the touch screen is a capacitive type, the proximity sensor 141 may be configured to detect the proximity of a conductive object based on changes in electric field depending on the proximity of the object. In this case, the touch screen (or touch sensor) itself may be classified as a proximity sensor.

Moreover, for convenience of description, an action of recognizing the position of an object on the touch screen as the object approaches the touch screen without touching it is called “proximity touch”, and an action of actually bringing an object into contact with the touch screen is called “contact touch”. A position where an object touches the touch screen in proximity refers to a position where the object vertically corresponds to the touch screen when the screen is touched in proximity by the object. The proximity sensor 141 may detect a proximity touch and a proximity touch pattern (for example, a proximity touch distance, a proximity touch direction, a proximity touch speed, a proximity touch time, a proximity touch position, and a proximity touch movement state). Moreover, the control unit 180 processes data (or information) corresponding to a proximity touch operation and a proximity touch pattern, detected through the proximity sensor 141, and then may output visual information corresponding to the processed data on the touch screen. Furthermore, the control unit 180 may control the mobile terminal 100 to process different operations or data (or information), depending on whether a touch at the same point on the touch screen is a proximity touch or a contact touch.

The touch sensor detects a touch (or touch input) applied to the touch screen (or display unit 151) by using at least one of various touch methods, including a resistive film method, a capacitive method, an infrared method, an ultrasonic method, and a magnetic field method.

In an example, the touch sensor may be configured to convert a pressure applied to a specific portion on the touch screen or a change in capacitance occurring at a specific portion into an electrical input signal. The touch sensor may be configured to detect the position, area, pressure, and capacitance of a touch applied on the touch screen by a touch object. Here, the touch object is an object that applies a touch on the touch sensor—for example, a finger, a touch pen, a stylus pen, or a pointer.

In this manner, when there is a touch input on the touch sensor, a corresponding signal(s) is sent to a touch controller. The touch controller processes the signal(s) and then transmits corresponding data to the control unit 180. Therefore, the control unit 180 may recognize which area of the display unit 151 is touched. Here, the touch controller may be a component separate from the control unit 180 or the control unit 180 itself.

Meanwhile, the control unit 180 may perform different controls or the same control depending on the type of a touch object touching the touch screen (or a touch key provided in addition to the touch screen). Whether to perform different controls or the same control depending on the type of a touch object may be determined according to the current operating state of the mobile terminal 100 or an application program running on it.

Moreover, the above-mentioned touch sensor and proximity sensor are provided separately or in combination, and may thus sense various types of touch, for example, short touch (or tap touch), long touch, multi-touch, drag touch, flick touch, pinch-in touch, pinch-out touch, swipe touch, and hovering touch, on the touch screen.

The ultrasonic sensor may recognize position information of a detection target by using ultrasonic waves. Meanwhile, the control unit 180 may calculate the position of a wave source through information detected by an optical sensor and a plurality of ultrasonic sensors. The position of the wave source may be calculated using the properties of light which is much faster than ultrasonic waves—that is, light reaches an optical sensor much faster than ultrasonic waves do. More specifically, the position of the wave source may be calculated using the time difference of arrival between ultrasonic waves and light as a reference signal.

Moreover, the camera 121 described as a component of the input unit 120 may include at least one among a camera sensor (for example, CCD and CMOS), a photo sensor (or image sensor), and a laser sensor.

The camera 121 and the laser sensor may be combined to detect a touch on a three-dimensional image by a detection target. The photo sensor may be stacked on a display element, and such a photo sensor is configured to scan the movement of a detection target approaching the touch screen. More specifically, the photo sensor has a row/column of photodiodes and transistors (TR) mounted on it to scant content placed on the photo sensor by using an electrical signal which changes with the amount of light applied to the photodiodes. That is, the photo sensor may calculate the coordinates of a detection target according to changes in light intensity and therefore obtain position information of the detection target.

The display unit 151 may display (output) information processed in the mobile terminal 100. For example, the display unit 151 may display execution screen information of an application program running on the mobile terminal 100 or user interface (UI) and graphic user interface (GUI) information corresponding to such execution screen information.

Additionally, the display unit 151 may be configured as a three-dimensional display unit displaying a three-dimensional image.

A three-dimensional display method—for example, a stereoscopic method (glasses method), an autostereoscopic (glasses-free method), a projection method (holographic method)—may be applied to the three-dimensional display unit.

The sound output unit 152 may output audio data that is received from the wireless communication unit 110 or stored in the memory 170, in call signal reception mode, call mode, recording mode, voice recognition mode, or broadcast reception mode. The sound output unit 152 may output a sound signal related to a function (for example, a call signal reception sound and a message reception sound) performed by the mobile terminal 100. The sound output unit 152 may include a receiver, a speaker, and a buzzer.

The haptic module 153 generates various haptic effects that the user can feel. A representative example of a haptic effect that the haptic module 153 generates is vibration. The intensity and pattern of vibration generated by the haptic module 153 may be controlled according to the user's selection or according to the control unit's setting. For example, the haptic module 153 may synthesize different vibrations and output them or output different vibrations sequentially.

The haptic module 153 may generate other various haptic effects besides vibration—for example, effects from a pin arrangement that moves vertically to a touching skin surface, the force of air injection or suction through an injection port or a suction port, brushing against the skin surface, electrode contact, stimulus of electrostatic force, and effects from the reproduction of cold/warm sense using an element capable of absorbing or emitting heat.

The haptic module 154 may be implemented to deliver a haptic effect through direct contact and enable the user to feel a haptic effect through the sensation of finger or arm muscles. Two or more haptic module 154 may be provided according to an aspect of the configuration of the mobile terminal 100.

The optical output unit 154 outputs a signal for notifying of an event occurrence by using light from a light source of the mobile terminal 100. An example of an event occurring in the mobile terminal 100 includes message reception, call signal reception, missed call, alarm, schedule notification, e-mail reception, and information reception through an application.

A signal outputted from the optical output unit 154 is implemented as the mobile terminal emits light of a single color or many colors to the front or the back. The signal output may be terminated when the mobile terminal detects the user's event confirmation.

The interface unit 160 may serve as a path to all external devices connected to the mobile terminal 100. The interface unit 160 may receive data from an external device, receive power and deliver it to each component in the mobile terminal 100, or transmit data in the mobile terminal 100 to an external device. For example, the interface unit 160 may include a wired/wireless headset port, an external charger port, a wired/wireless data port, a memory card port, a port connecting a device equipped with an identification module, an audio I/O port, a video I/O port, and an earphone port.

Meanwhile, the identification module is a chip storing various information for authenticating the use of the mobile terminal 100, and may include a user identity module (UIM), a subscriber identity module (SIM), and a universal subscriber identity module (USIM). A device equipped with an identification module (hereinafter referred to as an identification device) may be manufactured in the form of a smart card. Accordingly, the identification device may be connected to the terminal 100 through the interface unit 160.

Moreover, when the mobile terminal 100 is connected to an external cradle, the interface unit 160 may serve as a path through which power from the cradle is supplied to the mobile terminal 100 or a path through which various command signals input from the cradle by the user are delivered to the mobile terminal 100. The various command signals or power input from the cradle may operate as a signal for recognizing that the mobile terminal 100 is correctly placed on the cradle.

The memory 170 may store a program for operating the control unit 180 and may temporarily store input/output data (for example, a phone book, a message, a still image, and a video). The memory 170 may store data on vibrations and sounds of various patterns which are output upon a touch input on the touch screen.

The memory 170 may include at least one type of storage medium among flash memory type, hard disk type. Solid State Disk (SSD) type, Silicon Disk Drive (SDD) type, multimedia card micro type, card type memory (for example, SD or XD memory type), random access memory (RAM), static random access memory (SRAM), read-only memory (ROM), electrically erasable programmable read-only memory (EEPROM), programmable read-only memory (PROM), magnetic memory, magnetic disk, and optical disk. The mobile terminal 100 may operate in relation to web storage performing a storage function of the memory 170 on the internet.

Meanwhile, as discussed above, the control unit 180 may control operations related to an application program and overall operations of the mobile terminal 100 in general. For example, if a state of the mobile terminal 100 satisfies set conditions, the control unit 180 may execute or release a lock state that limits input of a control command to applications from the user.

Additionally, the control unit 180 may perform a control or processing relating to a voice call, data communication, and a video call, or may perform pattern recognition processing for recognizing handwriting input or drawing input on the touch screen as a text and an image, respectively. Furthermore, the control unit 180 may control at least one of the above components or a combination thereof in order to implement various embodiments to be described below on the mobile terminal 100.

The power supply unit 190 may receive external power or internal power under control of the control unit 180 and may then supply power necessary for operation of each component. The power supply unit 190 includes a battery. The battery is a rechargeable built-in battery, and may be detachably coupled to a terminal body for charging or the like.

Additionally, the power supply unit 190 may include a connection port, and the connection port may be configured as one example of the interface unit 160 to which an external charger for supplying power to charge the battery is electrically connected.

As another example, the power supply unit 190 may be configured to charge the battery in a wireless manner without using the connection port. In this case, the power supply unit 190 may receive power from an external wireless power transmission device through at least one between an inductive coupling method based on magnetic induction and a magnetic resonance coupling method based on electromagnetic resonance.

Meanwhile, various embodiments below may be implemented within a recording medium readable by a computer or a similar device, by using software, hardware, or a combination thereof.

Referring now to FIGS. 1B and 1C, the disclosed mobile terminal 100 includes a terminal body with a bar shape. However, the present invention is not limited thereto, and may be applied to various structures such as a watch type, a clip type, a glass type, a folder type in which two or more bodies are coupled to be relatively movable, a flip type, a slide type, a swing type, and a swivel type. The mobile terminal may be related to a specific type; however, the description related to the specific type of the mobile terminal may be generally applied to mobile terminals of other types.

In this case, the terminal body may be understood as the mobile terminal 100 which is regarded as at least one assembly.

The mobile terminal 100 includes a case (for example, a frame, a housing, a cover, and the like) forming the external appearance. As shown in the drawings, the mobile terminal 100 may include a front case 101 and a rear case 102. Various electronic parts are disposed in an inner space formed by the attachment of the front case 101 and the rear case 102. At least one middle case may be additionally disposed between the front case 101 and the rear case 102.

The display unit 151 may be arranged on the front surface of the terminal body to output information. As shown in the drawings, a window 151a of the display unit 151 may be mounted to the front case 101 to form the front surface of the terminal body together with the front case 101.

In some cases, electronic components may also be mounted to the rear case 102. Examples of such electronic components include a detachable battery, an identification module, and a memory card. A rear cover 103 for covering the electronic components may be detachably coupled to the rear case 102. Therefore, when the rear cover 103 is detached from the rear case 102, the electronic components mounted to the rear case 102 are externally exposed.

As shown in the drawings, when the rear cover 103 is coupled to the rear case 102, the side of the rear case 102 may partially be exposed. In some cases, the rear case 102 may be completely covered by the rear cover 103 when they are coupled together. Meanwhile, the rear cover 103 may include an opening for externally exposing a camera 121b or an audio output unit 152b.

The cases 101, 102, 103 may be formed by injection molding a synthetic resin, or may be formed of a metal, for example, stainless steel (STS), aluminum (Al), titanium (Ti), or the like.

As an alternative to the example in which the plurality of cases form an inner space for accommodating various electronic components, the mobile terminal 100 may be configured such that one case forms the inner space. In this case, a mobile terminal 100 having a uni-body may be implemented in such a manner that synthetic resin or metal extends from a side surface to a rear surface.

Meanwhile, the mobile terminal 100 may include a waterproof portion (not shown) to prevent water from penetrating into the terminal body. For example, the waterproof portion may be provided between the window 151a and the front case 101, between the front case 101 and the rear case 102, or between the rear case 102 and the rear cover 103, and may include a waterproofing member for hermetically sealing the inner space when those cases are coupled together.

The mobile terminal 100 may include a display unit 151, first and second audio output units 152a and 152b, a proximity sensor 141, an illumination sensor 142, an optical output unit 154, first and second cameras 121a and 121b, first and second manipulation units 123a and 123b, a microphone 122, and an interface unit 160.

Hereinafter, as shown in FIGS. 1B and 1C, the display unit 151, the first audio output unit 152a, the proximity sensor 141, the illumination sensor 142, the optical output unit 154, the first camera 121a, and the first manipulation unit 123a are arranged on the front surface of the terminal body, the second manipulation unit 123b, the microphone 122 and the interface unit 160 are arranged on the side of the terminal body, and the second audio output unit 152b and the second camera 121b are arranged on the rear surface of the terminal body.

However, it is to be understood that these components are not limited to the above arrangement. Some of these components may be omitted, replaced or rearranged. For example, the first manipulation unit 123a may not be provided on the front surface of the terminal body, and the second audio output unit 152b may be provided on the side of the terminal body, not on the rear surface of the terminal body.

The display unit 151 displays (outputs) information processed in the mobile terminal 100. For example, the display unit 151 may display execution screen information of an application program running on the mobile terminal 100 or user interface (UI) and graphic user interface (GUI) information corresponding to such execution screen information.

The display unit 151 may include at least one among a liquid crystal display (LCD), a thin film transistor-liquid crystal display (TFT LCD), an organic light-emitting diode display (OLED), a flexible display, a 3D display, and an e-ink display.

Also, two or more display units 151 may be provided according to an implementation of the mobile terminal 100. In this case, a plurality of display units may be spaced apart from one another or integrally disposed on one side of the mobile terminal 100, or may be respectively disposed on different sides.

The display unit 151 may also include a touch sensor which senses a touch input for the display unit 151, whereby a control command may be input by a touch manner. When a touch is input to the display unit 151, the touch sensor may be configured to sense the touch, and the control unit 180 may be configured to generate a control command corresponding to the touch. The content input by the touch method may be text or numbers, or a menu item which can be indicated or designated in various modes.

The touch sensor may be configured in the form of a film having a touch pattern, disposed between the window 151a and a display (not shown) on a rear surface of the window 151a, or a metal wire which is patterned directly on the rear surface of the window 151a. Alternatively, the touch sensor may be formed integrally with the display. For example, the touch sensor may be disposed on a substrate of the display or within the display.

The display unit 151 may also form a touch screen together with the touch sensor. In this case, the touch screen may serve as the user input unit 123 (see FIG. 1A). As the case may be, the touch screen may replace at least some of the functions of the first manipulation unit 123a.

The first audio output unit 152a may be implemented in the form of a receiver to transfer a call sound to the ears of the user, and the second audio output unit 152b may be implemented in the form of a loud speaker to output various alarm sounds or reproduced multimedia sounds.

The window 151a of the display unit 151 may include a sound hole for emitting sound generated by the first audio output unit 152a. However, the present invention is not limited to this configuration, and the sound may be emitted along an assembly gap between structures (for example, a gap between the window 151a and the front case 101). In this case, a hole independently formed for audio output may not be seen or may be hidden, making the appearance of the mobile terminal 100 simpler.

The optical output unit 154 is configured to output light for indicating occurrence of an event. Examples of the event include message reception, call signal reception, missed call, alarm, schedule notification, email reception, information reception through an application. Upon detecting the user's acknowledgment of the event, the control unit can control the optical output unit 154 to stop the light output.

The first camera 121a processes image frames of a still image or video obtained by an image sensor in a capture mode or a video call mode. The processed image frames may be displayed on the display unit 151 or stored in the memory 170.

The first and second manipulation units 123a and 123b are examples of the user input unit 123 which is manipulated by the user to receive a command for controlling the operation of the mobile terminal 100. The first and second manipulation units 123a and 123b may also be commonly referred to as a manipulating portion, and may employ any tactile manner that allows the user to perform manipulation such as touch, push, scroll, or the like. The first and second manipulation units 123a and 123b may also employ any non-tactile manner that allows the user to perform manipulation such as proximity touch, hovering, or the like.

In this figure, the first manipulation unit 123a is illustrated as a touch key, but the present invention is not limited thereto. For example, the first manipulation unit 123a may be a push key (mechanical key) or a combination of a touch key and a push key.

Various input may be received by the first and second manipulation units 123a and 123b a menu, home key, cancel, search, or the like, and the second manipulation unit 123b may receive commands such as control of the volume of sounds output from the first or second audio output unit 152a or 152b, transition of the display unit 151 to touch recognition mode, and the like.

As another example of the user input unit 123, a rear input unit (not shown) may be arranged on the rear surface of the terminal body. The rear input unit is manipulated to receive commands for controlling the operation of the mobile terminal 100, and various inputs may be received. For example, commands such as power on/off, start, end, and scroll, control of the volume of sounds output from the first and second audio output units 152a and 152bm and commands such as transition of the display unit 151 to touch recognition mode may be received. The rear input unit may be implemented in such a manner as to enable touch input, push input, or a combination thereof.

The rear input unit may be located to overlap the display unit 151 of the front side in a thickness direction of the terminal body. As one example, the rear input unit may be located on an upper end portion of the rear side of the terminal body such that the user can easily manipulate it using a forefinger when the user grabs the terminal body with one hand. However, the present invention is not necessarily limited to this, and the position of the rear input unit may be changed.

When the rear input unit is provided on the rear surface of the terminal body, a new user interface may be implemented. Also, when the touch screen or the rear input unit as described above replaces at least some functions of the first manipulation unit 123a provided on the front surface of the terminal body so that the first manipulation unit 123a is omitted from the front surface of the terminal body, the display unit 151 can have a larger screen.

The mobile terminal 100 may include a fingerprint recognition sensor for recognizing a fingerprint of the user. The control unit 180 may use fingerprint information detected through the fingerprint recognition sensor as an identification means. The fingerprint recognition sensor may be incorporated in the display unit 151 or the user input unit 123.

The microphone 122 may receive the user's voice and other sounds. The microphone 122 may be provided in a plurality of places to receive stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as a Subscriber Identification Module (SIM), a User Identity Module (UIM), or a memory card for information storage.

The second camera 121b may be located on the rear side of the terminal body, and its image capturing direction is substantially opposite to the image capturing direction of the first camera 121a.

The second camera 121b may include a plurality of lenses arranged along at least one line. The plurality of lenses may also be arranged in a matrix configuration. This type of camera may be referred to as an “array camera.” When the second camera 121b is configured as an array camera, images may be captured in various manners using the plurality of lenses, and images with better quality may be acquired.

A flash 124 may be arranged to adjoin the second camera 121b. When an image of a subject is captured with the second camera 121b, the flash 124 may illuminate the subject.

The second audio output unit 152b may additionally be arranged on the terminal body. The second audio output unit 152b may implement stereophonic sound functions in conjunction with the first audio output unit 152a, and may be also used for implementing a speaker phone mode for call communication.

At least one antenna for wireless communication may be located on the terminal body. The antenna may be embedded in the terminal body or formed on the case. For example, an antenna which constitutes a part of the broadcast receiving module 111 (see FIG. 1A) may be retractable into the terminal body. Alternatively, an antenna may be formed using a film attached to an inner surface of the rear cover 103, or a case comprising a conductive material may be configured to serve as the antenna.

The power supply unit 190 (see FIG. 1A) for supplying power to the mobile terminal 100 is provided on the terminal body. The power supply unit 190 may be embedded in the terminal body, or may include a battery 191 that is configured to be detachably coupled to the outside of the terminal body.

The battery 191 may be configured to receive power via a power cable connected to the interface unit 160. Also, the battery 191 may be configured to be recharged in a wireless manner using a wireless charger. Wireless charging may be implemented by magnetic induction or resonance manner (electromagnetic resonance).

Meanwhile, in the drawings, the rear cover 103 is shown coupled to the rear case 102 for shielding the battery 191, to prevent separation of the battery 191 and protect the battery 191 from external impact or from impurities. When the battery 191 is made detachable from the terminal body, the rear case 103 may be detachably coupled to the rear case 102.

An accessory for protecting the appearance or assisting or extending the functions of the mobile terminal 100 may also be provided on the mobile terminal 100. As one example of the accessory, a cover or pouch for covering or accommodating at least one side of the mobile terminal 100 may be provided. The cover or pouch may interface with the display unit 151 to extend the function of the mobile terminal 100. Another example of the accessory is a touch pen for assisting or extending touch input to the touch screen.

As seen from above, the configuration of the mobile terminal 100 according to the present invention has been described with reference to FIG. 1A to IC. Hereinafter, a mobile terminal that identifies terminal users having the same interest as a user of the mobile terminal and proposes group generation and a group activity, and a method for controlling the same, according to an exemplary embodiment of the present invention will be described in detail.

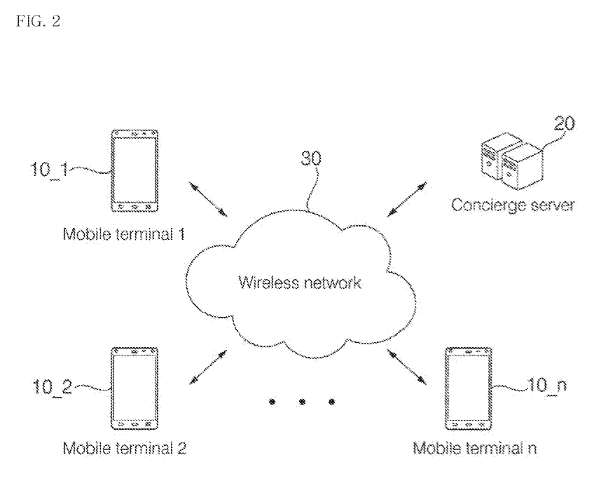

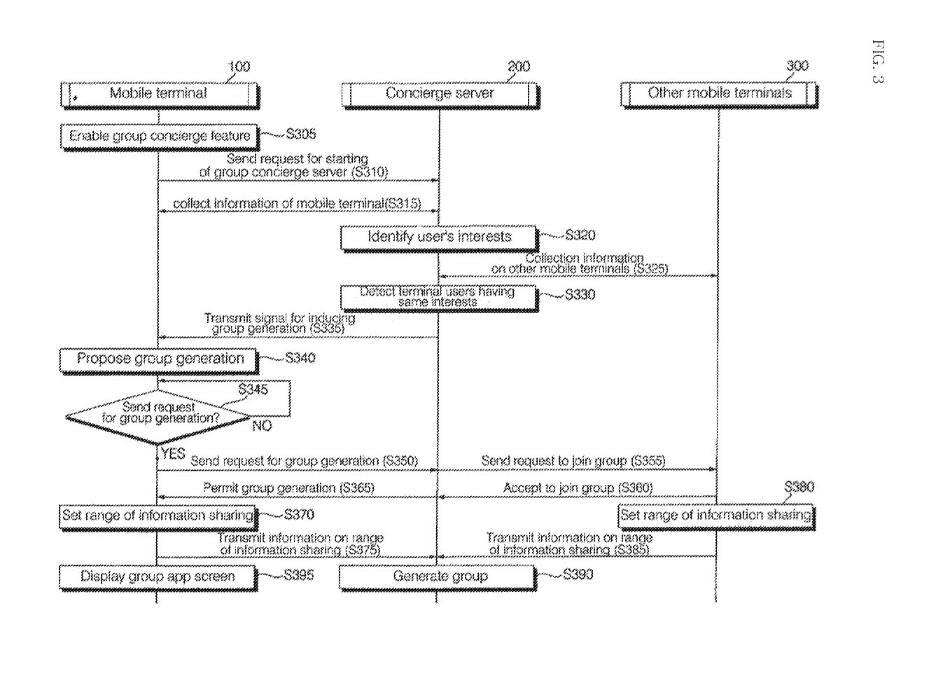

FIG. 2 is a schematic view of a configuration of a communication system that provides a concierge server according to the present invention.

Referring to FIG. 2, a communication system 50 according to an exemplary embodiment of the present invention may include a plurality of mobile terminals 10_1 to 10_n, a concierge server 20, and a wireless network 30.

The concierge server 20 performs the function of collecting various information from the plurality of mobile terminals 10_1 to 10_n connected to the wireless network 30 and identifying the terminal users' interests.

Moreover, the concierge server 200 performs the function of identifying terminal users having the same interest as a user of a particular mobile terminal and encouraging the user to generate a group.

In addition, the concierge server 200 performs the function of continuously identifying information on terminal users belonging to a particular group by group and providing to the mobile terminal information relating to the group members' common interests.

The concierge server 20 may be provided by, but not limited to, the manufacturer of mobile terminals that come with a group concierge feature or by the communication provider of the group concierge feature.

The plurality of mobile terminal 10_1 to 10_n come with a group concierge feature that proposes group generation and a group activity. Such a group concierge feature may be installed by default by a manufacturer or may be installed by downloading an application from the App store.

When the group concierge feature is enabled, the plurality of mobile terminals 10_1 to 10_n may connect to the concierge server 20 over the wireless network 30, and receive information on group generation and group activities from the connected concierge server and provide it to the users.

Furthermore, the plurality of mobile terminals 10_1 to 10_n may use a smart notification feature in conjunction with the group concierge feature.

FIG. 3 is a process flowchart illustrating an operation in which a group concierge service is provided in a communication system according to an exemplary embodiment of the present invention.

Referring to FIG. 3, the mobile terminal 100 may enable the group concierge feature in response to a user command (S305). For instance, the mobile terminal 100 may enable the group concierge feature

When the group concierge feature is enabled, the mobile terminal 100 may connect to the concierge server 200 over the wireless network and transmit to the connected concierge server 200 a signal asking to initiate the group concierge service (S310).

Upon receiving the request to initiate the group concierge service, the concierge server 200 may collect location information of the mobile terminal 100, smart notification information, website access information, website browsing information, app use information, photographic information, multimedia information, call information, message information, email information, messenger information. SNS information, etc. (S315). In this case, the concierge server 200 may be configured to collect only the information allowed in advance by the mobile terminal 100 to ensure privacy protection of individuals and security.

The concierge server 200 may identify the user's interests based on information collected from the mobile terminal 100 (S320). Meanwhile, in another embodiment, the concierge server 200 may receive information about the user's interests identified by the mobile terminal 100.

The concierge server 200 may collect location information of the mobile terminal 100, smart notification information, website access information, website browsing information, app use information, photographic information, multimedia information, call information, message information, email information, messenger information, SNS information, etc. from other terminals 300 connected to the wireless network (S325). Likewise, the concierge server 200 may be configured to collect only the information allowed in advance by these terminals 300 to ensure privacy protection of individuals and security.

The concierge server 200 may detect terminal users having the same interest as the user of the mobile terminal 100 by using at least one of multiple pieces of information received from the mobile terminal 100 or collected from other terminals 300 (S330).

In this case, the concierge server 100 may detect people with the same interest from among terminal users (i.e., the user's acquaintances) acquired from address book information or SNS friend information. Also, the concierge server 100 may detect anonymous people with the same interest as the user of the mobile terminal 100 by using collective intelligence data.

Afterwards, the concierge server 200 may transmit a signal encouraging group generation and information needed for group generation to the mobile terminal 100 (S335). Here, the information needed for group generation may include information about the user's interests and information on terminal users having the same interest as the user.

The mobile terminal 100 may display on the display unit 151 a notification window or notification screen proposing group generation, based on information received from the concierge server 200 (S340).

Upon receiving a user command asking to generate a group while the notification window or notification screen is displayed (S345), the mobile terminal 100 may transmit a signal asking for group generation to the concierge server 200 (S350). Having received the group generation request, the concierge server 200 may transmit a signal asking terminal users with the same interests as the user of the mobile terminal 100 to subscriber to a group (S355).

Having received such a group subscription request, other terminals 300 may accept or reject the group subscription request from the concierge server 200 in response to a user command. Upon receiving a signal accepting the group subscription request from one or more other terminals 300 (S360), the concierge server 200 may transmit to the mobile terminal 100 a signal permitting group generation (S365). In this case, the concierge server 200 may transmit to the mobile terminal 100 information on other terminals 300 that have accepted the group subscription request.

When generating a group, the mobile terminal 100 may set the types and range of information that can be collected by the concierge server 200 (S370). Also, the mobile terminal 100 may transmit to the concierge server 200 information on the set types and range of information (S375). Accordingly, information on a mobile terminal used for a group concierge service may be configured to include only the name of the group and information relating to common interests.

Likewise, when subscribing to a group, other terminals 300 may set the types and range of information that can be collected by the concierge server 200 (S380). Also, other terminals 300 may transmit to the concierge server 200 information on the set types and range of information (S385).

The concierge server 200 may generate a group consisting of the user of the mobile terminal 100 who requested group generation and the users of other terminals 300 who accepted the group subscription (S390). Afterwards, the concierge server 200 may continuously identify information, life patterns, inclinations, etc. of the members of the group and suggest a group activity or a group meeting.

Meanwhile, upon completion of group generation, the mobile terminal 100 may display on the display unit 151 the execution screen (hereinafter, “group app screen”) of a group app in response to a user command or the like, and present on the group app screen various information provided from the concierge server 200 (S395).

As stated above, a communication system according to an exemplary embodiment of the present invention may identify other terminal users with the same interests as the user of the mobile terminal and suggest group generation, and continuously identify life patterns, inclinations. etc. of the members of the group and suggest a group activity or a group meeting.

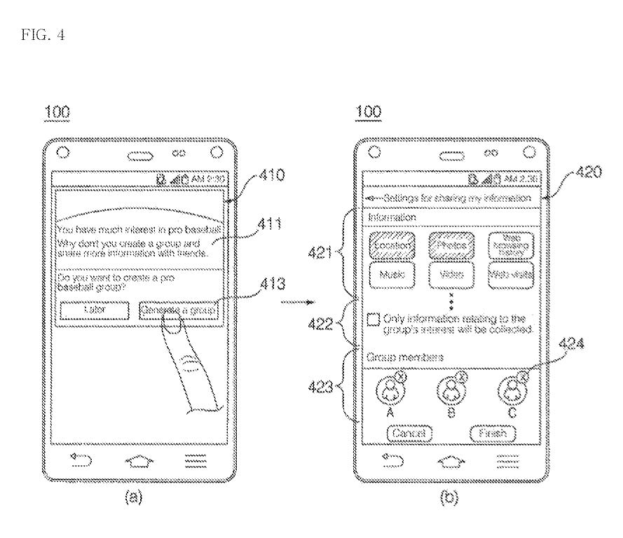

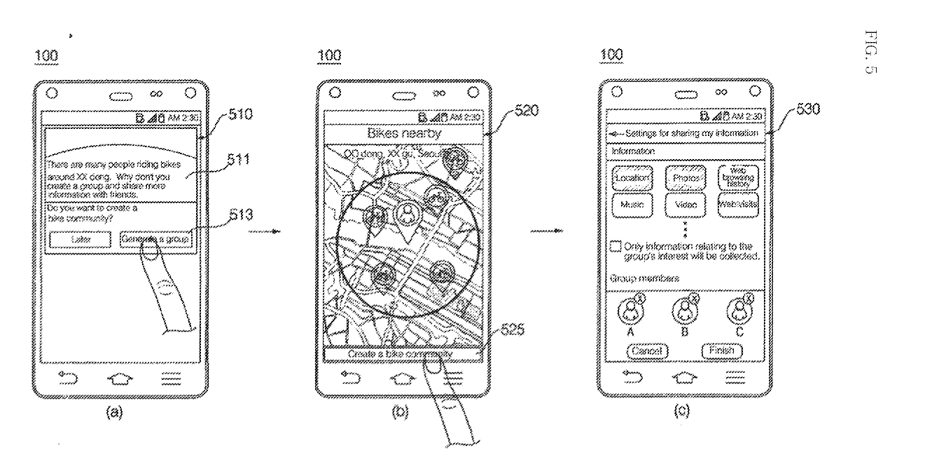

FIG. 4 is a view used as a reference to explain a mobile terminal's operation for identifying people with the same interests as the user among the user's acquaintances and suggesting group creation.

Referring to FIG. 4, the mobile terminal 100 may enable a group concierge feature in response to a user command or the like. When the group concierge feature is enabled, the mobile terminal 100 may transmit to the concierge server 200 a signal asking to initiate a group concierge service.

Meanwhile, the mobile terminal 100 may specify in advance how to create a group based on user input through the Settings menu in a group app. That is, the mobile terminal 100 may select in advance to create a group of acquaintances with the same interests as the user.

Having received a group concierge service initiation request, the concierge server 200 may collect various information from the mobile terminal 100 and identify the user's interests. Hereinafter, this embodiment will be described assuming that the user is interested in “baseball”.

Moreover, the concierge server 200 may connect to address book information or SNS friend information in the mobile terminal 100 and acquire information on the user's acquaintances. Also, the concierge server 200 may collect the mobile phone data of the acquaintances and detect terminal users with the same interest as the user of the mobile terminal 100. Afterwards, the concierge server 200 may transmit to the mobile terminal 100 a signal encouraging group creation.

The mobile terminal 100 may display on the display unit 151 a notification window (or concierge card) 410 containing user interest information, information 411 suggesting group creation, and a group creation icon 413. For instance, as shown in (a) of FIG. 4, the mobile terminal 100 may display on the display unit 151 notification information, saying “You have much interest in pro baseball. Why don't you create a group and share more information with friends?”

Upon receiving a user input for selecting the group creation icon 413, the mobile terminal 100 may transmit to the concierge server 200 a signal asking for group creation. Afterwards, upon receiving a signal accepting group creation form the concierge server 200, the mobile terminal 100 may display on the display unit 151 an information sharing settings screen 420 shown in (b) of FIG. 4.

The information sharing settings screen 420 may include an information selection area 421 for selecting the types of information that can be collected by the concierge server 200, a security setting area 422 for setting the range of information that can be collected by the concierge server 200, and a group member area 423 encompassing the members of the group.

The information selection area 421 may include location information, photos, web browsing history information, web visit information, music information, video information, app use history information, call information, message information, email information, messenger information, and SNS information. In the information selection area 421, information selected by the user may be displayed in such a way as to be distinguishable from information not selected by the user.

In the security setting area 422, the range of information that can be collected by the concierge server 200 may be restricted to ‘information related to the interest of the group’, which is enabled by selecting the checkbox. Accordingly, only the information relating to the interest (i.e., pro baseball) of the group may be collected from the mobile terminal and used for the group concierge service.

In the group member area 423, an add icon (not shown) or a delete icon 424 may be additionally included to delete someone from the members of the group or add someone to the group.

FIG. 5 is a view used as a reference to explain a mobile terminal's operation for identifying anonymous people with the same interests as the user among the user's acquaintances through collective intelligence and suggesting group creation.

Referring to FIG. 5, the mobile terminal 100 may enable the group concierge feature in response to a user command or the like. When the group concierge feature is enabled, the mobile terminal 100 may transmit to the concierge server 200 a signal asking to initiate a group concierge service.

Meanwhile, the mobile terminal 100 may specify in advance how to create a group based on user input through the Settings menu. That is, the mobile terminal 100 may select in advance to create a group of anonymous people with the same interests as the user through collective intelligence.

Having received a group concierge service initiation request, the concierge server 200 may collect various information from the mobile terminal 100 and identify the user's interests. Hereinafter, this embodiment will be described assuming that the user is interested in ‘biking’.

The concierge server 100 may detect anonymous people having the same interest as the user of the mobile terminal 100 or doing the same activity by using collective intelligence data collected from a plurality of mobile terminals connected to a wireless network. In this case, the concierge server 200 may detect anonymous users having the same interest in the user's surroundings and all over the world. Afterwards, the concierge server 200 may transmit to the mobile terminal 100 a signal encouraging group creation.

The mobile terminal 100 may display on the display unit 151 a notification window 510 containing user interest information, information 511 suggesting group creation, and a group creation icon 513. For instance, as shown in (a) of FIG. 5, the mobile terminal 100 may display on the display unit 151 notification information, saying “There are many people riding bikes around XX dong. Why don't you create a group and share more information with friends?”

Upon receiving a user input for selecting the group creation icon 413, the mobile terminal 100 may display on a map screen 520 location information of people with the same interest as the user.

When a certain area is designated by user input on the map screen 520, the mobile terminal 100 may select anonymous people who are in the designated area as members of the biking community.

Upon receiving a user input for selecting a biking community creation icon 525, the mobile terminal 100 may transmit to the concierge server 200 a signal asking for group creation. Afterwards, upon receiving a signal accepting group creation form the concierge server 200, the mobile terminal 100 may display on the display unit 151 an information sharing settings screen 530 shown in (b) of FIG. 5. Since the information sharing settings screen 530 is identical to the information sharing setting screen 420 shown in (c) of FIG. 4, a detailed description thereof will be omitted.

As seen from above, referring to FIGS. 4 and 5, a method of creating a group of acquaintances or anonymous people having the same interest as the user of the mobile terminal 100 has been described in detail. Hereinafter, apart from the above-described method of creating a group based on interest, a method of creating a group by neighboring device recognition, a method of creating a group based on location information, a method of creating a group based on AP/hotspot, and a method of creating a group based on app information will be described.

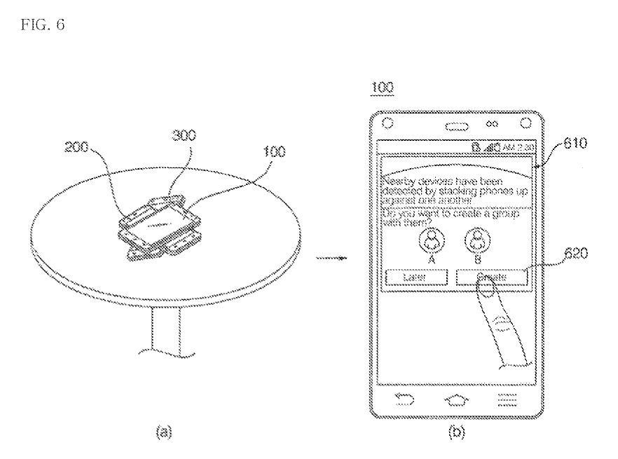

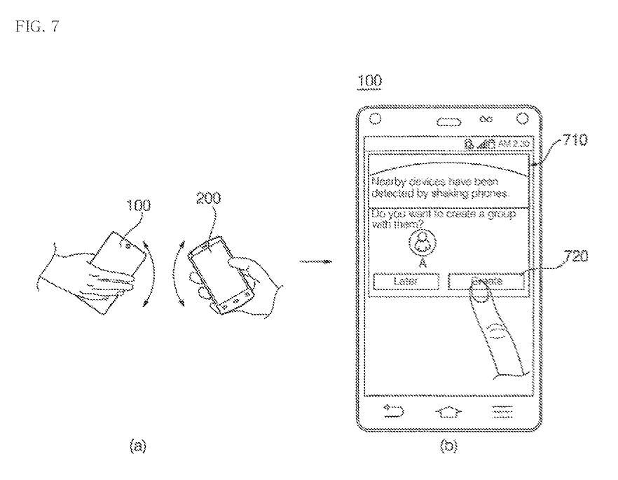

FIGS. 6 to 11 are views used as a reference to explain various methods of suggesting group creation by neighboring device recognition.

FIG. 6 is a view used as a reference to explain a mobile terminal's operation for suggesting group creation based on phone stacking.

Referring to FIG. 6, a plurality of mobile terminals 100, 200, and 300 may be stacked up against one another, and then the mobile terminals 100, 200, and 300 may detect nearby devise through their sensing unit and suggest group creation. In this case, it is assumed that the plurality of mobile terminals 100, 200, and 300 come with a group concierge feature that suggests group creation and a group activity.

For instance, as shown in (b) of FIG. 6, the first mobile terminal 100 may display on the display unit 151 a notification window 610, saying “Nearby devices have been detected by stacking phones up against one another. Do you want to create a group with them?”. Accordingly, the user of the mobile terminal 100 may create a new group with nearby devices by selecting a group creation icon 620.

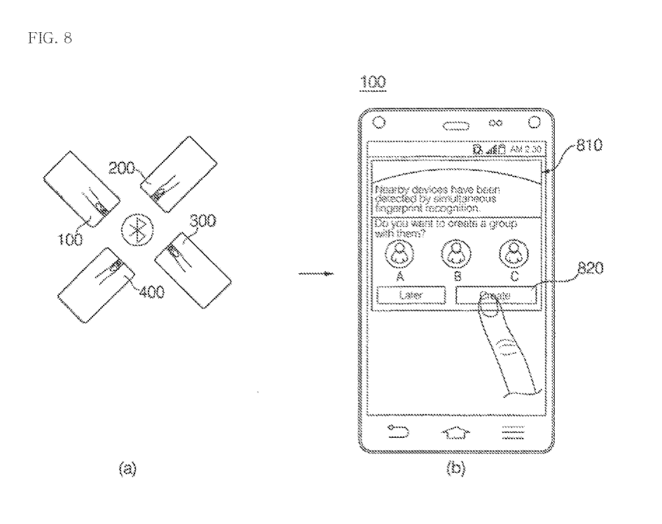

FIG. 7 is a view used as a reference to explain a mobile terminal's operation for suggesting group creation based on phone shaking.

Referring to FIG. 7, if a first user and a second user shake a first mobile terminal 100 and a second mobile terminal 200, respectively, that are close to each other, the first and second mobile terminals 100 and 200 may detect nearby devices through the sensing unit and suggest group creation. Likewise, it is assumed that the first and second terminals 100 and 200 come with a group concierge feature that suggests group creation and a group activity.

For instance, as shown in (b) of FIG. 7, the first mobile terminal 100 may display on the display unit 151 a notification window 710, saying “Nearby devices have been detected by shaking phones. Do you want to create a group with them?”. Accordingly, the user of the mobile terminal 100 may create a new group with nearby devices by selecting a group creation icon 720.

Although not shown in the drawings, it will be obvious to those skilled in the art that it is possible to create a new group with neighboring devise via other various gesture inputs, apart from the above phone stacking motion and phone shaking motion.

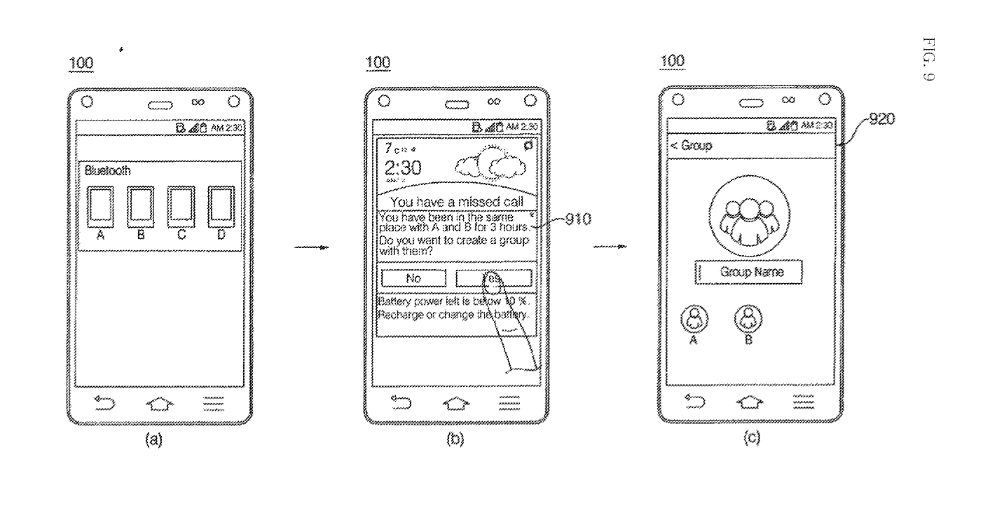

FIG. 8 is a view used as a reference to explain a mobile terminal's operation for suggesting group creation based on simultaneous fingerprint recognition.

Referring to FIG. 8, if first to fourth users touch the fingerprint recognition sensor located on the back of their terminal for a certain length of time, first to fourth terminals 100 to 400 may broadcast out a signal indicating the occurrence of a group creation event. The first to fourth mobile terminals 100 to 400 may sense a broadcast signal and detect nearby devices, and suggest group creation based on the detected devices.

For instance, as shown in (b) of FIG. 8, the first mobile terminal 100 may display on the display unit 151 a notification window 810, saying “Nearby devices have been detected by simultaneous fingerprint recognition. Do you want to create a group with them?”. Accordingly, the user of the mobile terminal 100 may create a new group with nearby devices by selecting a group creation icon 820.

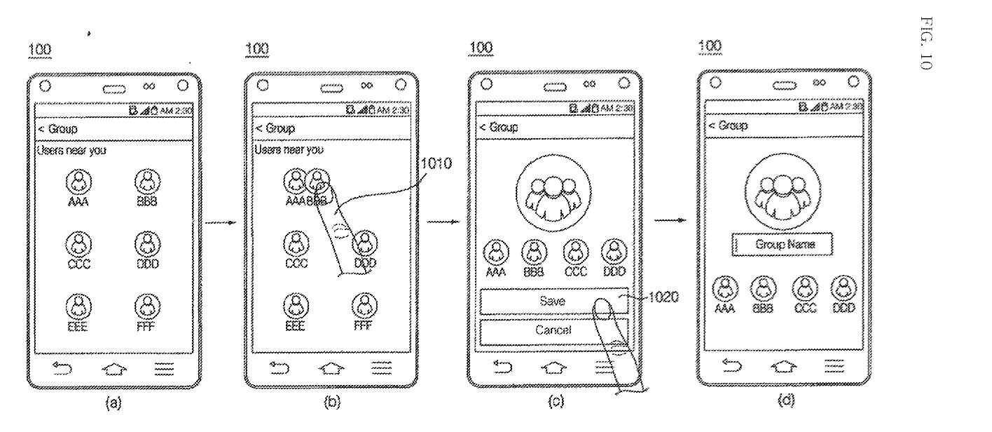

FIG. 9 is a view used as a reference to explain a mobile terminal's operation for suggesting group creation based on location and time information of a neighboring device.

Referring to FIG. 9, the mobile terminal 100 may detect Bluetooth-enabled devices among nearby devices in response to a user command and display them on the display unit 151. Then, the mobile terminal 100 may detect devices that have been in the same place for a certain amount of time, among the Bluetooth-enabled devices, and suggest group creation.

For instance, as shown in (b) of FIG. 9, the first mobile terminal 100 may display on the display unit 151 a notification window 910, saying “You have been in the same place with A and B for 3 hours. Do you want to create a group with them?”.

Upon receiving a user command asking for group creation through the notification window 910, the mobile terminal 100 may display on the display unit 151 a screen 920 for setting the group's name, as shown in (c) of FIG. 9. In this way, the user of the mobile terminal 100 may create a new group based on location and time information of a neighboring device.

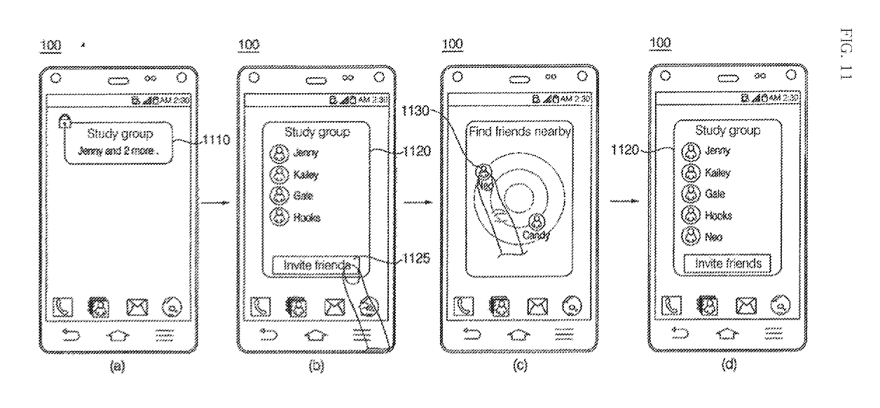

FIG. 10 is a view used as a reference to explain a mobile terminal's operation for suggesting group creation based on location and time information of a neighboring device.

Referring to FIG. 10, the mobile terminal 100 may detect devices registered in its address book among nearby devices in response to a user command or the like and display them on the display unit 151. In this case, the detected devices may be displayed as icons on the display unit 151.

Upon receiving a gesture input (not shown) for selecting the icons displayed on the display unit 151 or a gesture input 1010 for dragging and dropping at least one icon over another icon, the mobile terminal 100 may select members of the group based on the received gesture input.

After completion of group members, when a save icon 1020 is selected, the mobile terminal 100 may display on the display unit 151 a screen 1030 for setting the name of a group to be created, as shown in (d) of FIG. 10. In this way, the user of the mobile terminal may create a new group based on location and time information of a neighboring device.

FIG. 11 is a view used as a reference to explain a mobile terminal's operation for adding a new group member based on location and time information of a neighboring device.

Referring to FIG. 11, upon completion of group creation, the mobile terminal 100 may display on the display unit 151 a locked group folder (or group widget) 1110.

When the group folder 1110 is unlocked via fingerprint recognition or by entering a password or pattern, the mobile terminal 100 may display on the display unit 151 a pop-up window 1120 containing icons of the members of the group and an invite icon 1125.

When the invite icon 1125 is selected, the mobile terminal 100 may detect devices registered in its address book among nearby devices and display them on the display unit 151. If one 1130 of the devices displayed on the display unit is selected, the mobile terminal 100 may add the user corresponding to the selected device 1130 as a new member.

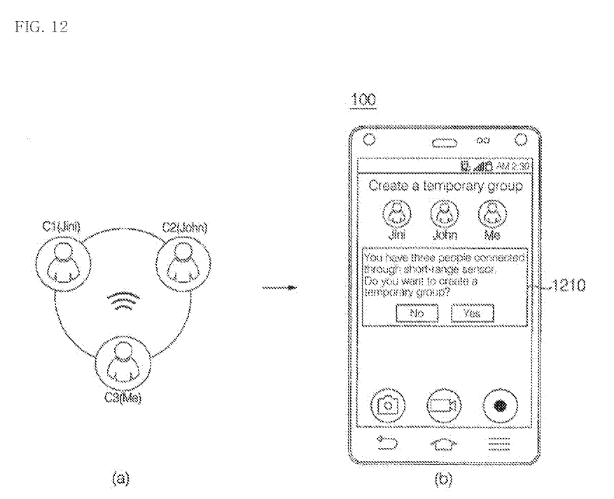

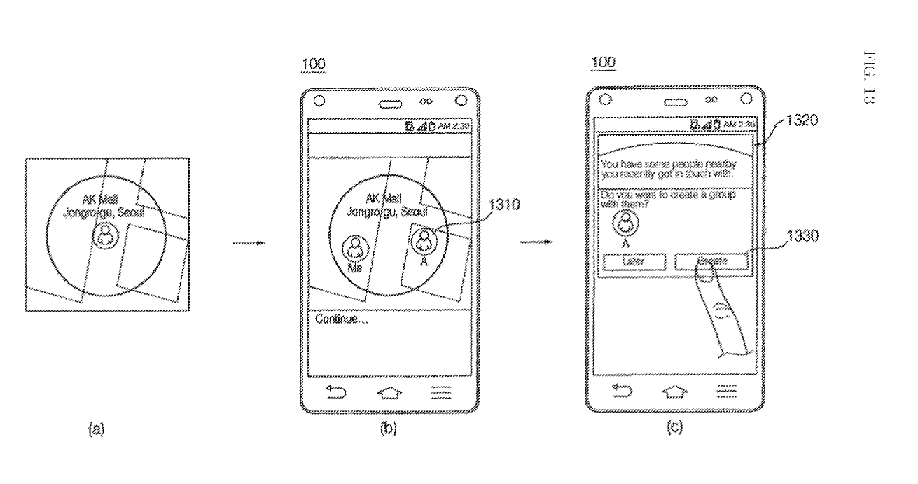

FIG. 12 is a view used as a reference to explain a mobile terminal's operation for suggesting group creation based on a short-range sensor and address book information.

Referring to FIG. 12, the mobile terminal 100 may detect devices registered in its address book among nearby devices by enabling a short-range sensor in response to a user command or the like.

Upon detecting devices via the short-range sensor, the mobile terminal 100 may display on the display unit 151 a notification window 1210 suggesting to create a temporary group with the users of the detected devices. Accordingly, the user of the mobile terminal 100 may create a new group with nearby devices via touch input on the notification window 1210.

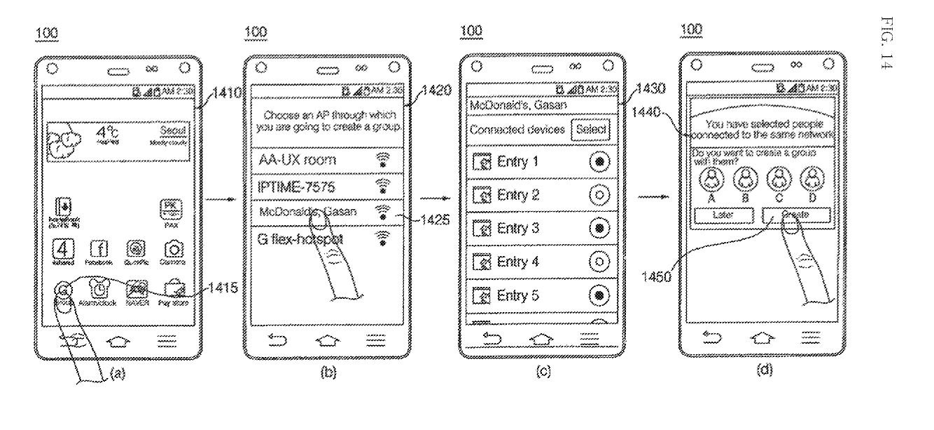

FIG. 13 is a view used as a reference to explain a mobile terminal's operation for suggesting group creation based on location and time information of a neighboring device.

Referring to FIG. 13, the mobile terminal 100 may detect its location via a GPS sensor or the like. Also, the mobile terminal 100 may detect devices of acquaintances who are within a certain distance from the current location and suggest group creation. In this case, the detected devices may be devices registered in the address book or devices the user recently got in touch with.

For instance, as shown in (b) and (c) of FIG. 13, upon detecting a device 1310 of an acquaintance within a certain distance, the mobile terminal 100 may display on the display unit 151 a notification window 1320, saying “You have some people nearby you recently got in touch with. Do you want to create a group with them?”. Accordingly, the user of the mobile terminal 100 may create a new group with nearby devices by selecting a group creation icon 1330.

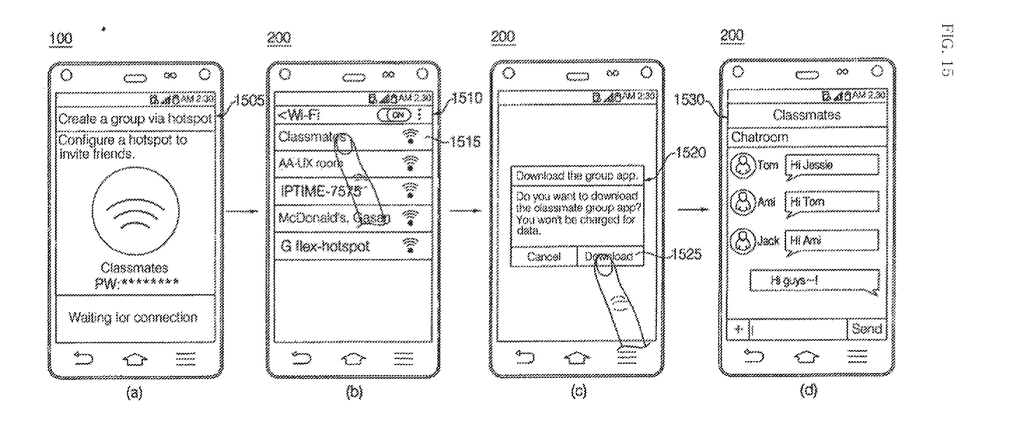

FIG. 14 is a view used as a reference to explain a mobile terminal's operation for suggesting group creation via an AP (access point).

Referring to FIG. 14, the mobile terminal 100 may access a group app 1415 shown on a home screen 1410 in response to a user command or the like and run a group creation menu (not shown).

When the group creation menu is run, the mobile terminal 100 may display on the display unit 151 an AP selection screen 1420 containing networks sensed from the current location. When a first AP 1425 is selected from the AP selection screen 1420, the mobile terminal 100 may display on the display unit 151 a device list screen 1430 containing devices connected to the selected first AP 1425. On the device list screen 1430, the names of people whose phone numbers are registered in the address book may be displayed, but, for those whose phone numbers are not registered, identification numbers of the devices may be displayed.

If one or more devices are selected from the device list screen 1430, the mobile terminal 100 may suggest group creation based on the selected devices.

For instance, as shown in (d) of FIG. 14, the mobile terminal 100 may display on the display unit 151 a notification window 1440, saying “You have selected people connected to the same network. Do you want to create a group with them?”. Accordingly, the mobile terminal the user of the mobile terminal 100 may create a new group with nearby devices by selecting a group creation icon 1450.

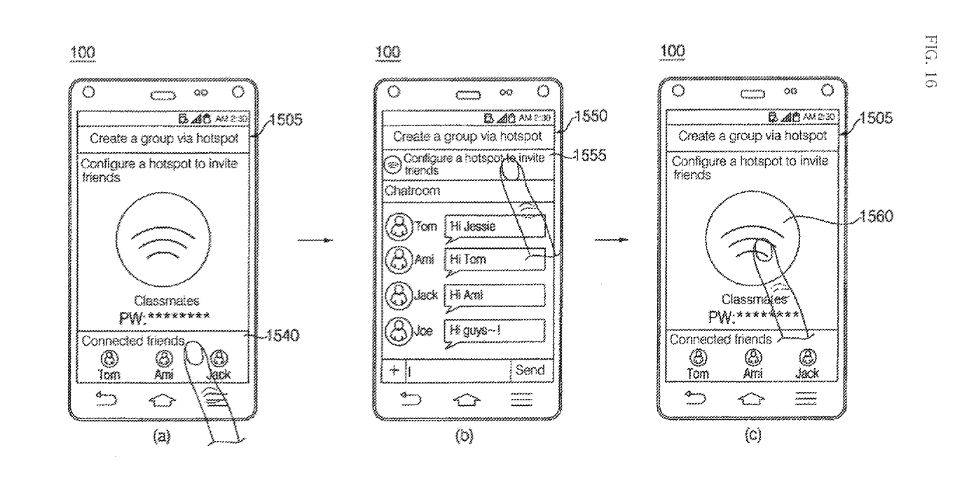

FIGS. 15 and 16 are views used as a reference to explain a mobile terminal's operation for suggesting group creation via a hotspot.

Referring to FIG. 15, a first mobile terminal 100 may set up a hotspot for inviting friends to create a new group in response to a user command or the like. When setting up a hotspot, the first mobile terminal 100 may display on the display unit 151 a hotspot group creation screen 1505.

A second mobile terminal 200 may display on the display unit 151 a network selection screen 1510 in response a user command or the like. In this case, the network selection screen 1510 may contain a hotspot 1515 preset by the user of the first mobile terminal 100.

The second mobile terminal 100 may connect to the hotspot 1515 by entering a password disclosed by the user of the first mobile terminal 100. Even if connected to the hotspot 1515, the second mobile terminal 200 may be configured to limit internet data usage.

Moreover, when connected to a hotspot, the second mobile terminal 200 may display on the display unit 151 a pop-up window 1520 suggesting to download and install a group app.

If a download icon 1525 is selected from the pop-up window 1520, the second mobile terminal 200 may download the group app from the first mobile terminal 100 and install it, and display the execution screen 1530 of the group app on the display unit 151. In this case the group app screen 1530 may be a chat screen consisting of friends connected to the hotspot 1515.

Meanwhile, referring to FIG. 16, the first mobile terminal 100 may display on a hotspot group creation screen 1505 a list 1540 of friends connected to the hotspot set up by it.

If a connection list area 1540 is selected while the hotspot group creation screen 1505 is displayed, the first mobile terminal 100 may display on the display unit 151 a chat screen 1550 consisting of friends connected to the hotspot. When a first area 1555 displayed on the chat screen 1550 is selected, the first mobile terminal 100 may display the hotspot group creation screen 1505 over again.

Meanwhile, if a wireless icon 1560 displayed on the hotspot group creation screen 1505 is selected, the first mobile terminal 100 may disable the currently connected hotspot after completing the creation of a group via the hotspot. However, even if the hotspot connection is disabled, currently running apps may remain and get the group concierge service from the concierge server.

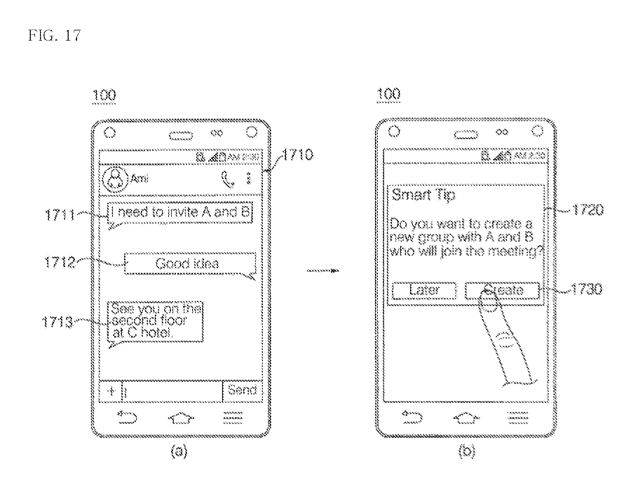

FIGS. 17 to 22 are views used as a reference to explain various methods for suggesting group creation based on app information.

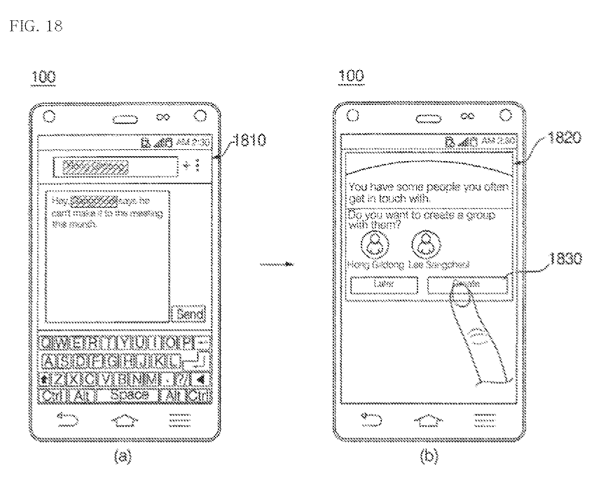

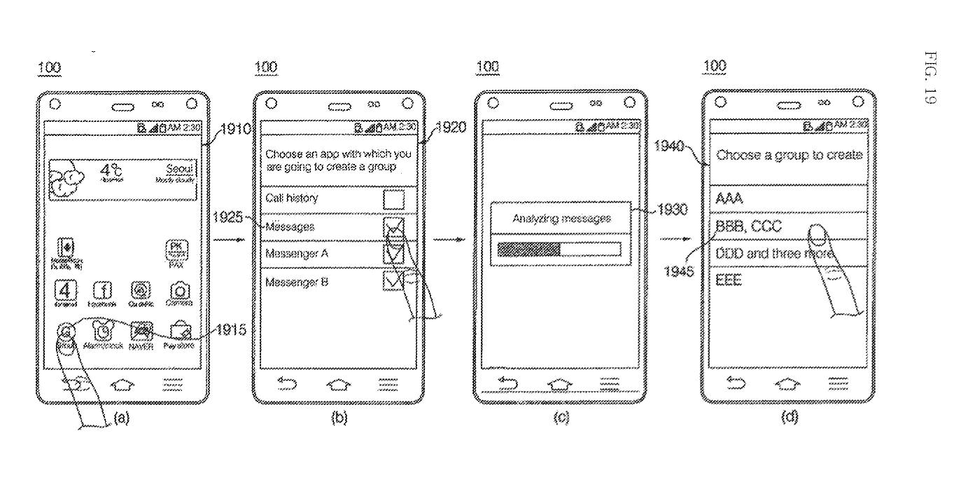

FIGS. 17 and 18 are views used as a reference to explain a mobile terminal's operation for suggesting group creation based on a communication message's content.

Referring to FIG. 17, the mobile terminal 100 may display on the display unit 151 a mobile messenger screen 1710 in response to a user command or the like. The user of the mobile terminal 100 may have a conversation with a person you want via the mobile messenger screen 1710.

When the mobile messenger application is finished, the mobile terminal 100 may analyze the content of messages 1711, 1712, and 1713 sent/received to and from the terminal of that person and suggest group creation.

For instance, as shown in FIG. 17, upon detecting people, a time, a place, etc. from the messages on the mobile messenger screen 1710, the mobile terminal 100 may display on the display unit 151 a notification window 1720, saying “Do you want to create a new group with A and B who will join the meeting?”. Accordingly, the user of the mobile terminal 100 may create a new group by selecting a group creation icon 1730.

Meanwhile, in another embodiment, referring to FIG. 18, the mobile terminal 100 may display on the display unit 151 a text message writing screen 1810 in response to a user command or the like. When sending an SMS/MMS message written on the text message writing screen 1810, the mobile terminal 100 may suggest group creation by analyzing the recipient' information and the content of the sent message.

For instance, as shown in FIG. 18, upon detecting people the user often gets in touch with by analyzing text messages sent to other terminals, the mobile terminal 100 may display on the display unit 151 a notification window 1820, saying “You have some people you often get in touch with. Do you want to create a group with them?”. Accordingly, the user of the mobile terminal 100 may create a new group by selecting a group creation icon 1830.

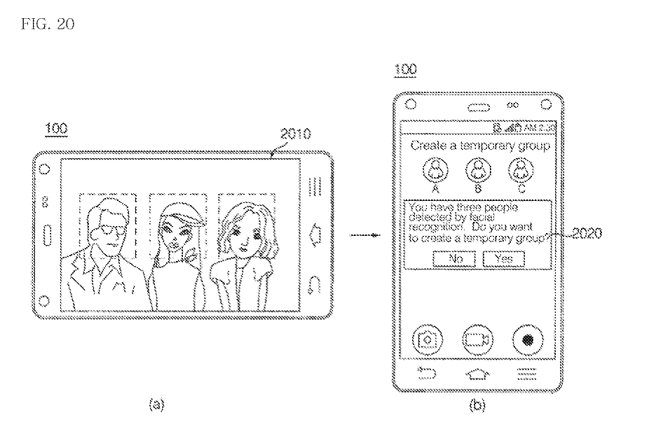

FIG. 19 is a view used as a reference to explain a mobile terminal's operation for suggesting group creation by analyzing information of a selected app.

Referring to FIG. 19, the mobile terminal 100 may access a group app 1915 shown on a home screen 1910 in response to a user command or the like and run a group creation menu (not shown).

When the group creation menu is run, the mobile terminal 100 may display on the display unit 151 an app selection screen 1920 containing applications related to communication. When a message application 1925 is selected from the app selection screen 1920, the mobile terminal 100 may analyze text messages sent/received via the message application. In this case, the mobile terminal 100 may display on the display unit 151 a pop-up window 1930 indicating that the text messages are being analyzed.

The mobile terminal 100 may display on the display unit 151 a group selection screen 1940 containing lists of people who can be classified based on the result of analyzing the text messages. Accordingly, the user of the mobile terminal 100 may create a new group by selecting a list 1945.

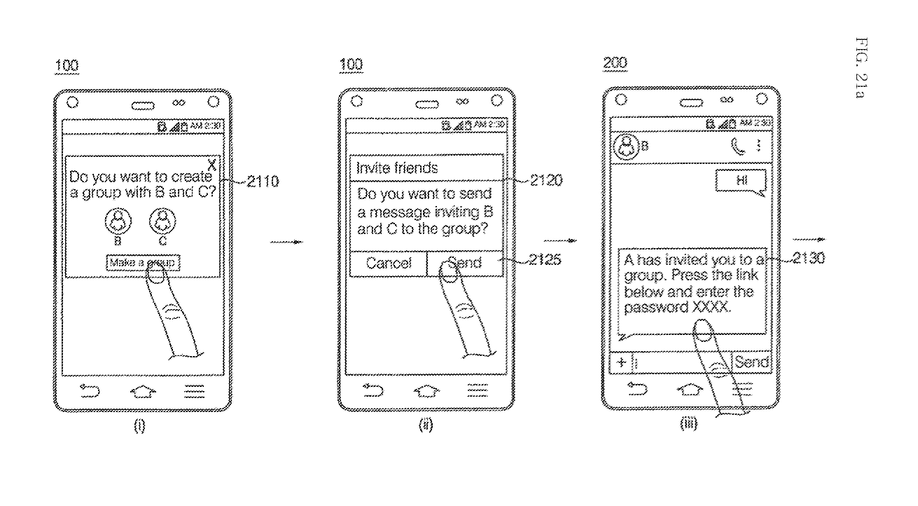

FIG. 20 is a view used as a reference to explain a mobile terminal's operation for suggesting temporary group creation via photo facial recognition.

Referring to FIG. 20, the mobile terminal 100 may take a photograph by running a camera application in response to a user command or the like. The mobile terminal 100 may recognize the faces of people in a photograph 2010 and then compare them to face images stored in its address book.

The mobile terminal 100 may detect people matching those in the photograph from the address book and suggest temporary group creation. For instance, as shown in (b) of FIG. 20, the mobile terminal 100 may display on the display unit 151 a notification window 2020, saying “You have three friends detected by photo face recognition. Do you want to create a temporary group?”.

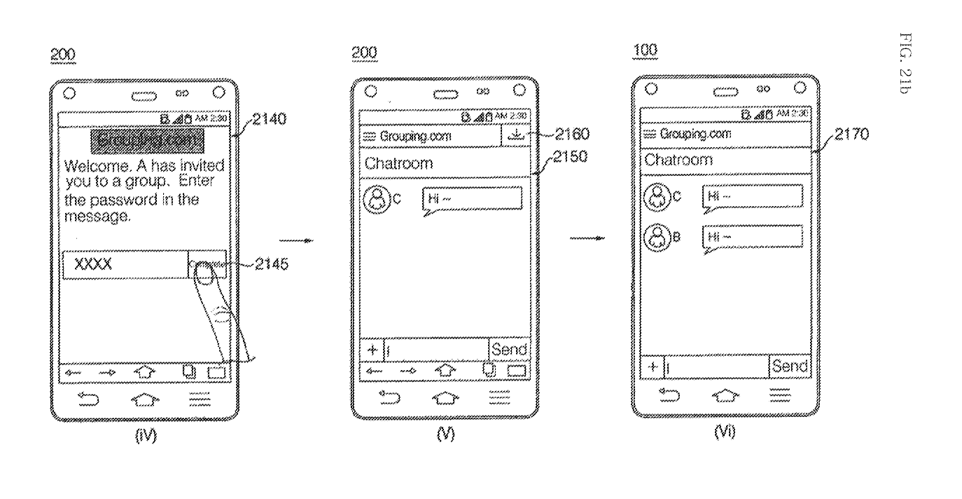

FIGS. 21A and 21B are views used as a reference to explain a mobile terminal's operation for suggesting group creation based on communication frequency.

Referring to FIG. 21A, a first mobile terminal 100 may suggest group creation by taking into account the frequency of phone calls, frequency of social networking, frequency of message transmission/reception, and frequency of email transmission/reception with other terminals.

For instance, as shown in FIG. 21A, if a high degree of frequency of phone calls or social networking with B and C is detected, the first mobile terminal 100 may display on the display unit 151 a notification window 2110, saying “Do you want to create a group with B and C?”.

Upon receiving a user command asking for group creation via the notification window 2110, the first mobile terminal 100 may display on the display unit 151 a pop-up window 2120 for sending an invitation message to B and C.

If a send icon 2125 of the pop-up window 2120 is selected, the mobile terminal 100 may send a friend invitation message to second and third mobile terminals B and C own.

The second mobile terminal 200 may display on the display unit 151 a friend invitation message 2130 received from the first mobile terminal 100. In this case, the friend invitation message 2130 may contain information on the person who sent the invitation, a password disclosed by that person, and web link information.

If the web link information contained in the friend invitation message 2130 is selected, the second mobile terminal 200 may display a predetermined webpage screen 2140 and a password entry window 2145 asking to enter the disclosed password.

Upon entering the password via the password entry window, the second mobile terminal 200 may display on the display unit 151 a group app screen (for instance, a group chat window) 2150. On the other hand, if the second mobile terminal 200 does not have the group app installed, the group may be downloaded and installed via a download icon 2160 shown at the right top.

Meanwhile, although not show in the drawings, a third mobile terminal (not shown) may likewise display on the display unit 151 a group app screen in the same process. Also, if B and C join the group, the first mobile terminal 100 may likewise display on the display unit 251 a group app screen 2170.

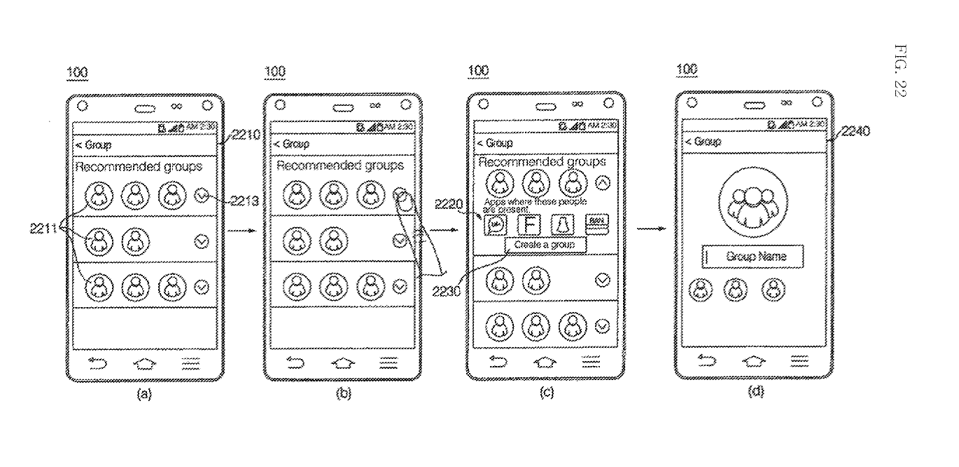

FIG. 22 is a view used as a reference to explain a mobile terminal's operation for suggesting group creation based on SNS friend information.

Referring to FIG. 22, the mobile terminal 100 may access a group app 1915 shown on a home screen (not shown) or app screen (not shown) in response to a user command or the like and run a group creation menu.

When the group creation menu is run, the mobile terminal 100 may display on the display unit 151 a group recommendation screen 2210 that finds people who are connected with the user on several SNS apps or messenger apps and suggests groups of various types. In this case, the group recommendation screen 2210 may contain icons 2211 indicating people for each recommended group and a view more icon 2213.

If the view more icon 2213 is selected, the mobile terminal 100 may additionally display information on apps 2220 where people in each recommended group are connected with the user and a group creation icon 2230.

If the group creation icon 2230 is selected, the mobile terminal 100 may display on the display unit 151 a screen 2240 for setting the group's name, as shown in (d) of FIG. 22. In this way, the user of the mobile terminal 100 may create a new group based on SNS friend information.

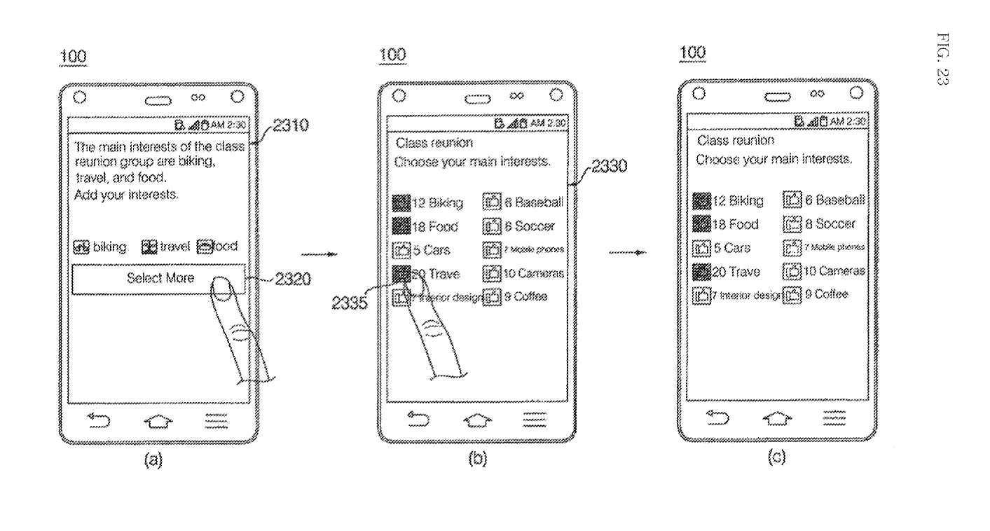

As seen from above, a mobile terminal's operations for suggesting group generation in various ways have been described in detail. Hereinafter, a mobile terminal's operations for continuously identifying information, life patterns, inclinations, etc. of the members of a group and providing information about the group's common interests will be described in detail with reference to FIGS. 23 to 31.

FIG. 23 is a view used as a reference to explain a process of specifying a group's common interests.

Referring to FIG. 23, the concierge server (not shown) may identify group members' common interests to some degree by continuously analyzing sends information on the phone data of the group members, and may automatically specify the group's common interests based on the identified interests of the group members.

When the concierge server sends information on the automatically specified common interests to the mobile terminal 100, the mobile terminal 100 may receive that information and display on the display unit 151 a notification window 2310 containing the information about the group's common interests. In this case, the automatically specified common interests of the group already reflect the interests of the mobile terminal 100 identified by the concierge server.

If an add icon 2320 shown on the notification window 2310 is selected, the mobile terminal 100 may display on the display unit 151 an interest statistics screen 2330 listing all the interests of the group members. The user of the mobile terminal 100 may manually select a category (e.g., travel) 2335 they want to add via the interest statistics screen 2330.

When selected to add a category, the mobile terminal 100 may increase the count of selected categories by 1. On the interest statistics screen 2330, three interest categories (e.g., biking, travel, and food) with the highest counts may be determined as the group's common interests, and the common interest categories may be displayed in such a way as to be distinguishable from other categories.

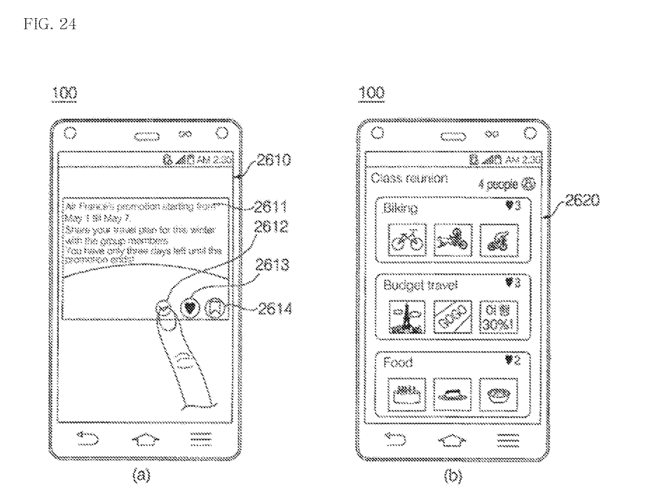

FIG. 24 is a view used as a reference to explain a mobile terminal's operation for providing information on group members interests.

Referring to FIG. 24, the concierge server may provide notification information relating to the group members' common interests or conversation topics to the mobile terminals of the group members. Also, the concierge server may provide notification information relating to the group members' personal interests or conversation topics to the mobile terminals of the group members.

The mobile terminal 100 may display on the display unit 151 a notification window 2410 containing information 2411 provided from the concierge server. In this case, the notification window 2410 may contain a view details menu 2412, a like menu 2413, and a view later menu 2414. The user of the mobile terminal 100 may provide feedback on information provided from the concierge server by selecting the menus 2413, 2413, and 2414 shown on the notification window 2410. The concierge server may provide more information the group members would like and less information that would elicit no response from them. Also, the concierge server may add personal interest information many people would like as the group's common interests.

Meanwhile, the mobile terminal 100 may access a group app shown on a home screen (not shown) in response to a user command or the like and display a group interest information screen 2420 on the display unit 151. Accordingly, the user of the mobile terminal 100 may share information about common interests with other group members via the group interest information screen 2420, and the group members may provide feedback to one another.

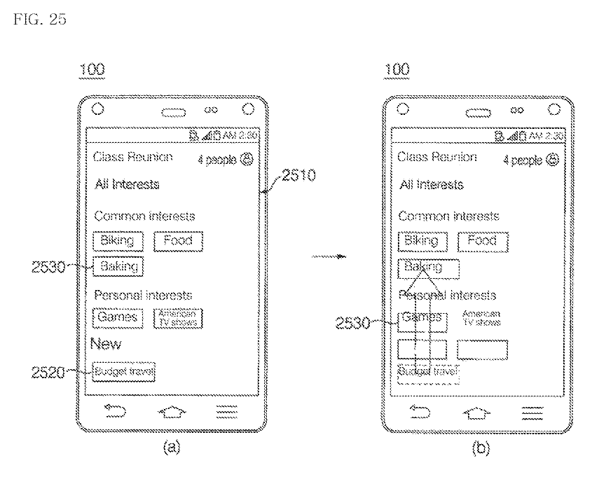

FIG. 25 is a view used as a reference to explain a mobile terminal's operation for updating a group's interest information in real time.

Referring to FIG. 25, the mobile terminal 100 may display on the display unit 151 an interest list screen 2510 listing the group's common interests and personal interests in response to a user command or the like. The interest information shown in the interest list screen 2510 may be arranged sequentially according to the popularity of interest information gathered from feedbacks from the group members.

Moreover, the mobile terminal 100 may display newly-registered interest information 2520 as a separate category at the bottom of the interest list screen 2510. If the newly-registered interest information 2250 gets an increasingly positive response from the group members, the mobile terminal 100 may move this interest information 2520 to the top of the interest list screen 2510. On the contrary, if the existing common interest information 2530 gets no response from the group members, the mobile terminal 100 may move this interest information 2530 to the bottom of the interest list screen 2510.

Meanwhile, the concierge server may analyze each group member's preference for the group's interests and their activity levels. Also, the concierge server may set the type and level of notification differently based on the analysis of each member's preference for the interests and their activity levels.

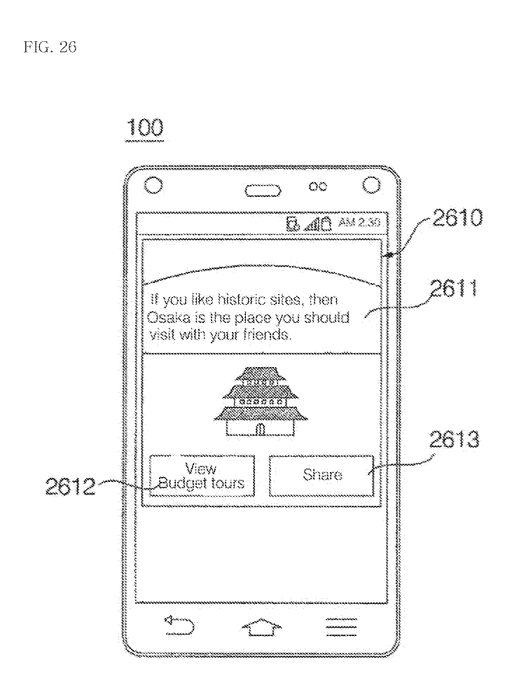

FIG. 26 is a view used as a reference to explain a mobile terminal's operation for providing information on products or services relevant to group members' interests.

Referring to FIG. 26, when suggesting activities relating to the group member's interests, the concierge server may recommend information on products or services relevant to the group member's interests.

The mobile terminal 100 may display on the display unit 151 a predetermined notification window 2610 based on information provided from the concierge server. In this case, the notification window 2610 may contain information 2611 suggesting a group activity, a menu 2612 suggesting products or services relevant to the group activity, and a menu 2613 for letting the user to share the group activity with other group members.

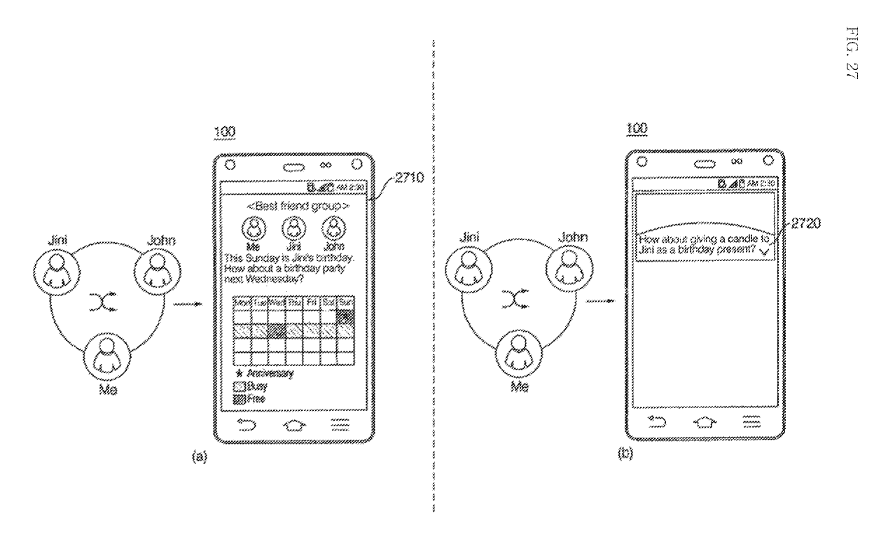

FIG. 27 is a view used as a reference to explain a mobile terminal's operation for providing information relating to a specific event for group members.

Referring to (a) of FIG. 27, when a group member's birthday event is coming up, the concierge server may check the group members' schedules by analyzing the mobile phone data (e.g., schedule dada) of the group members. The concierge server may suggest to the group members a meeting activity related to the birthday event based on the group members' schedules.

The mobile terminal 100 may display on the display unit 251 a notification window 2710 shown in (b) of FIG. 27 based on information provided from the concierge server. In this case, the notification window 2710 may contain information suggesting the date and place of a meeting, along with information on the group member who will be having a birthday.

Meanwhile, the concierge server may recommend foods the birthday person like or presents the birthday person will love. Accordingly, the mobile terminal 100 may display on the display unit 151 a notification window 2720 containing information recommendation information provided from the concierge server.

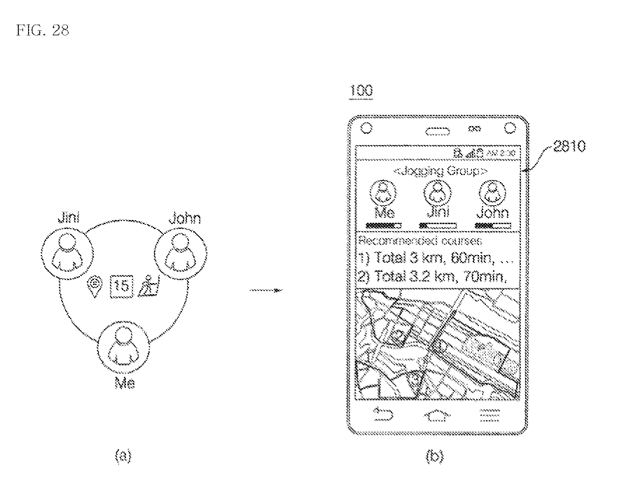

FIG. 28 is a view used as a reference to explain a mobile terminal's operation for suggesting an exercise course by assessing the exercise histories of group members.

Referring to FIG. 28, the concierge server may assess the exercise histories and health status of the group members by analyzing the mobile phone data of the group members. The concierge server may recommend a route of a difficulty level the group members can jog together based on the group members' usual amount of exercise.

The mobile terminal 100 may display on the display unit 151 a notification window 2810 containing recommended route information provided from the concierge server. Accordingly, the user of the mobile terminal may use one of the exercise routes recommended by the concierge server.

Moreover, the concierge server may adjust their pace by letting the group members to share their health status with one another during an exercise.

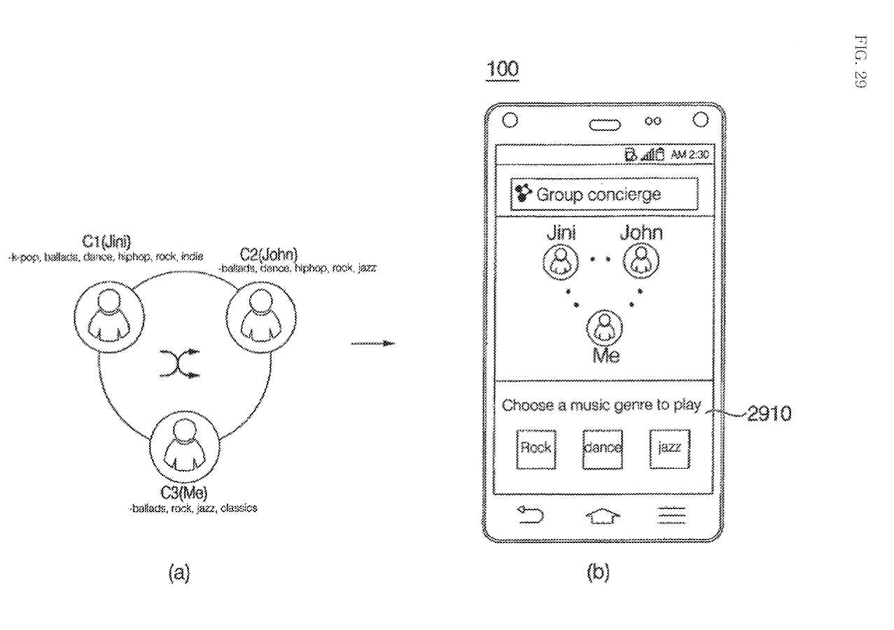

FIG. 29 is a view used as a reference to explain a mobile terminal's operation for recommending group playlists by identifying group members' tastes in music.

Referring to FIG. 29, the concierge server may identify the group members' favorite music genres and their tastes in music by analyzing the mobile phone data of the group members. The concierge server may create and recommend group playlists based on the group members' common tastes in music.

The mobile terminal 100 may display on the display unit 151 a notification window 2910 containing group playlists provided from the concierge server. Accordingly, the user of the mobile terminal 100 may choose a music genre they want from the group playlists and listen to the music.

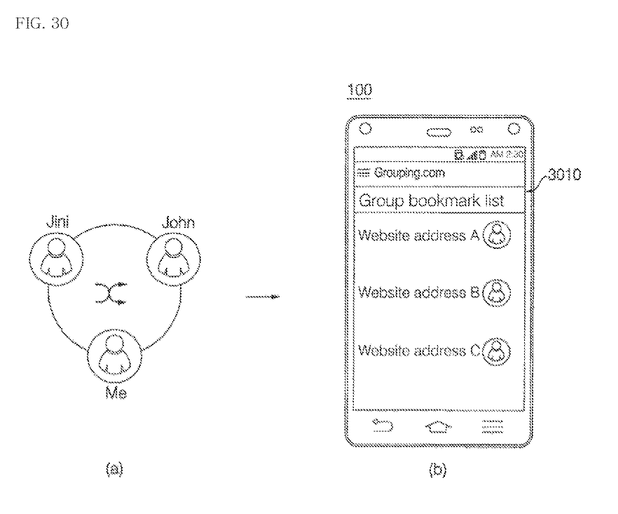

FIG. 30 is a view used as a reference to explain a mobile terminal's operation for providing a group bookmark list by checking group members' bookmark information.

Referring to FIG. 30, the concierge server may check bookmark information recently saved by the group members by analyzing the mobile phone data of the group members. The concierge server may create and recommend a group bookmark list based on bookmark information relating to the group members' interests.

The mobile terminal 100 may display on the display unit 151 a group app screen 3010 containing a group bookmark list provided from the concierge server. Accordingly, the user of the mobile terminal may choose one of the website addresses on the group bookmark list and access that website.

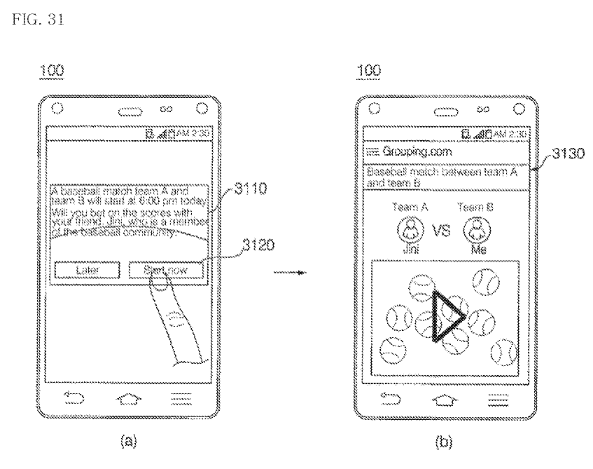

FIG. 31 is a view used as a reference to explain a mobile terminal's operation for encouraging group members to play a game or something like that relating to a group members' common interest.

Referring to FIG. 31, the concierge server may identify the group members' common interests by continuously identifying the mobile phone data of the group members. If the group members have a common interest in a sports match, the concierge server may check a sports match schedule and suggest that the group members to have a bet on the score.

The mobile terminal 100 may display on the display unit 151 a notification window 3110 shown in (a) of FIG. 31 based on information provided from the concierge server. In this case, the notification window 3110 may contain information about the sports match and information suggesting that the user have a bet with other group members on the score.

If a start icon 3120 is selected from the notification window 31110, the mobile terminal 100 may display on the display unit a group app screen 3230 containing information related to the bet on the score.

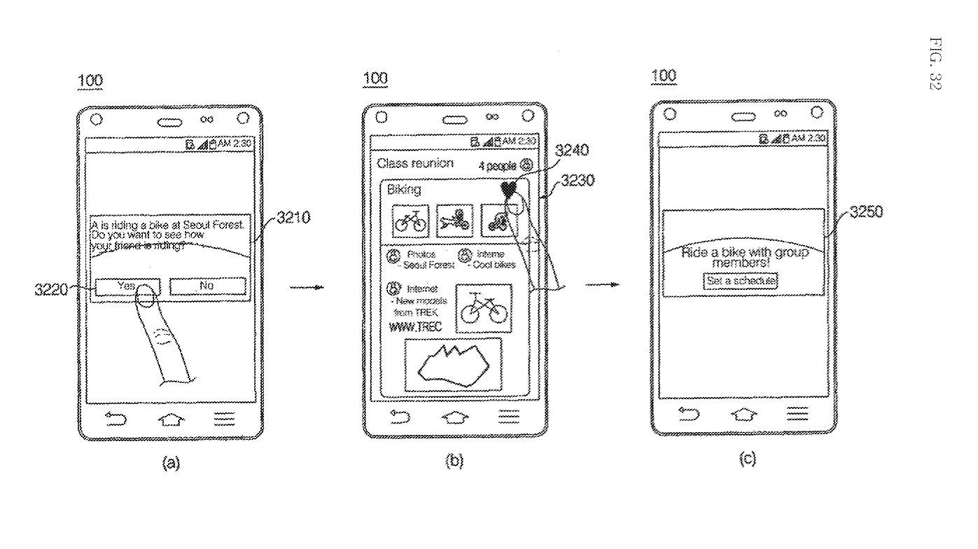

FIG. 32 is a view used as a reference to explain a mobile terminal's operation for suggesting other group members' interests.

Referring to FIG. 32, the concierge server may identify other group members' interests by continuously analyzing their mobile phone data. Also, the concierge server may suggest other group members' interests to the user of the mobile terminal 100.

The mobile terminal 100 may display on the display unit 151 a notification window 3210 created based on information provided from the concierge server. In this case, the notification window 3210 may contain information suggesting other group members' interests.

If a ‘Yes’ icon 3220 is selected from the notification window 3210, the mobile terminal 100 may display on the display unit 151 a group app screen 3230 containing activities relating other group members' interests. If the user of the mobile terminal 100 is interested in a group member' interest, they may select a ‘Like’ icon 3240 shown on the group app screen 3230 and provide feedback to the concierge server.

Meanwhile, if a group member's interest is determined as a common interest of the group, the mobile terminal 100 may display on the display unit 151 a notification window 3250 suggesting an activity every group member can enjoy.

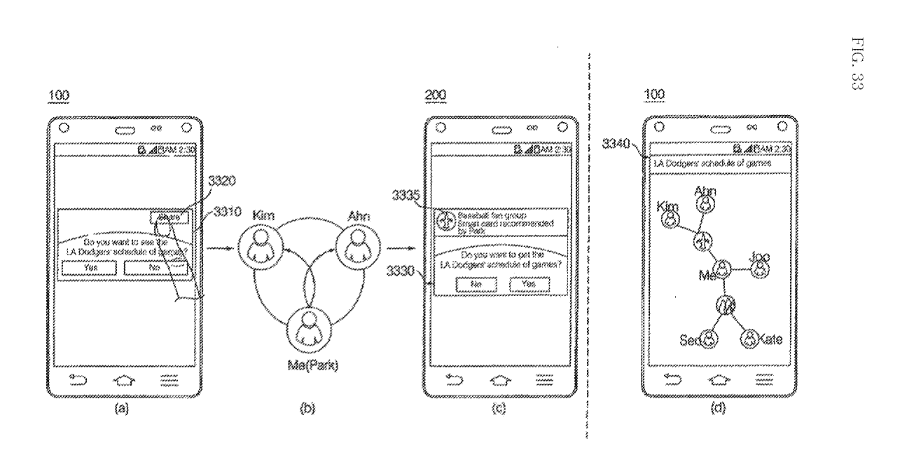

FIG. 33 is a view used as a reference to explain a mobile terminal's operation for sharing interest information provided from the concierge server with other group members.

Referring to FIG. 33, the first mobile terminal 100 may display on the display unit 151 a notification window 3310 containing interest information provided from the concierge server. If a share icon 3320 in the notification window 3310 is selected, the first mobile terminal 100 may share the interest information with other group members via the concierge server.

The second mobile terminal 200 may display on the display unit 151 a notification window 3330 containing interest information the user of the first mobile terminal 100 shares. In this case, the notification window 3330 may contain information on the group's name and group member information 3335 of the group member sharing the interest information. Accordingly, group members who have received the shared interest information may check the group profile and the sharer and then use that group member's interest information.

Meanwhile, as shown in (d) of FIG. 33, the first mobile terminal 100 may display on the display unit 151 a screen 3340 showing the group sharing the user's interest information and the group members in a tree structure. Accordingly, the user of the mobile terminal may see at a glance whom in which group they share their interest information with.

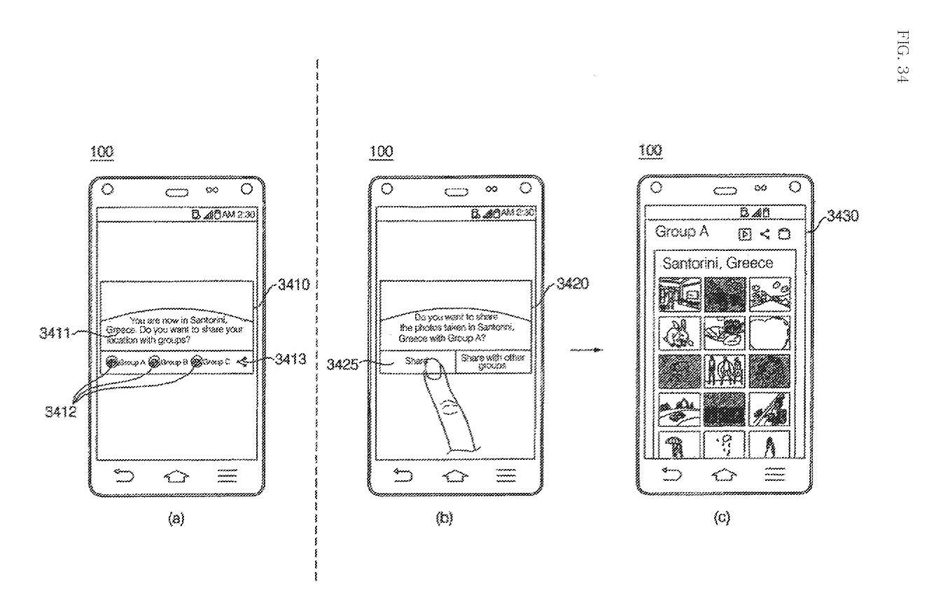

FIG. 34 is a view used as a reference to explain a mobile terminal's operation for suggesting to share their location and photos.

Referring to (a) of FIG. 34, if the user of the mobile terminal 100 visits a new place, the concierge server may turn the user's state into a sharable format and suggest to share the user's status and location with the group.

The mobile terminal 100 may display to the display unit 151 a notification window 3410 containing information suggested by the concierge server. In this case, the notification window 3410 may contain information 3411 suggesting to share the user's location, one or more group icons 3412, and a share icon 3413. The user of the mobile terminal 100 may select multiple groups or SNS apps via the group icons 3412 and the share icon 3413.

Meanwhile, referring to (b) of FIG. 34, if the user of the mobile terminal 100 takes photos in a new place, the concierge server may turn the user's status into a sharable format and automatically sort their photos and suggest to share them with relevant groups.

The mobile terminal 100 may display on the display unit 151 a notification window 3420 containing information suggested by the concierge server. If a share icon 3425 in the notification window 3420 is selected, the mobile terminal 100 may display on the display unit 151 an image list screen 3430 containing photos to share. The user of the mobile terminal 100 may remove or add pictures as the user wishes. Also, the user of the mobile terminal 100 may make a snap video using the photos on the image list screen 3430 and share it.

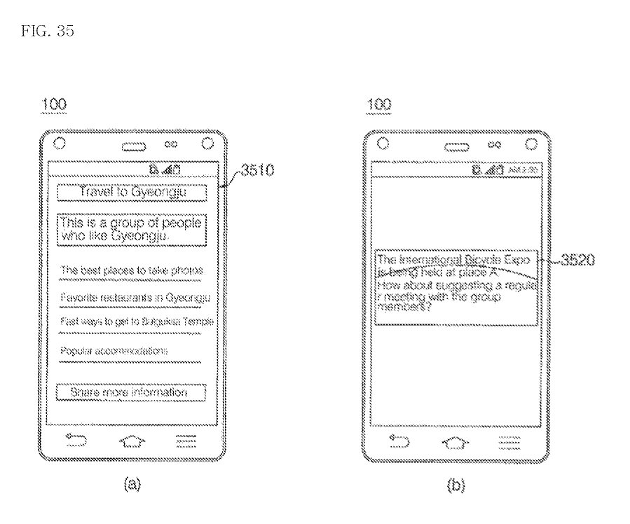

Hereinafter, a mobile terminal's operations for providing services such as reproducing collective intelligence and automatically sharing intelligence in a collective intelligence-based group will be described in detail with reference to FIGS. 35 to 38.

FIG. 35 is a view used as a reference to explain a mobile terminal's operation for reproducing and automatically sharing collective intelligence related to group members' interests.

Referring to (a) of FIG. 35, the concierge server may reproduce and automatically share collective intelligence related to group members' interests by analyzing the mobile phone data of the members of a particular group. Accordingly, the mobile terminals of the group members may display on the display unit 151 a group app screen 3510 containing collective intelligence reproduced by the concierge server.

Meanwhile, referring to (b) of FIG. 35, the concierge server may regularly suggest information on seminars, exhibitions. etc. that match the tastes of the members of a collective intelligence-based group. Accordingly, the mobile terminals of the group members may display on the display unit 151 a notification window 3520 containing information suggested by the concierge server.

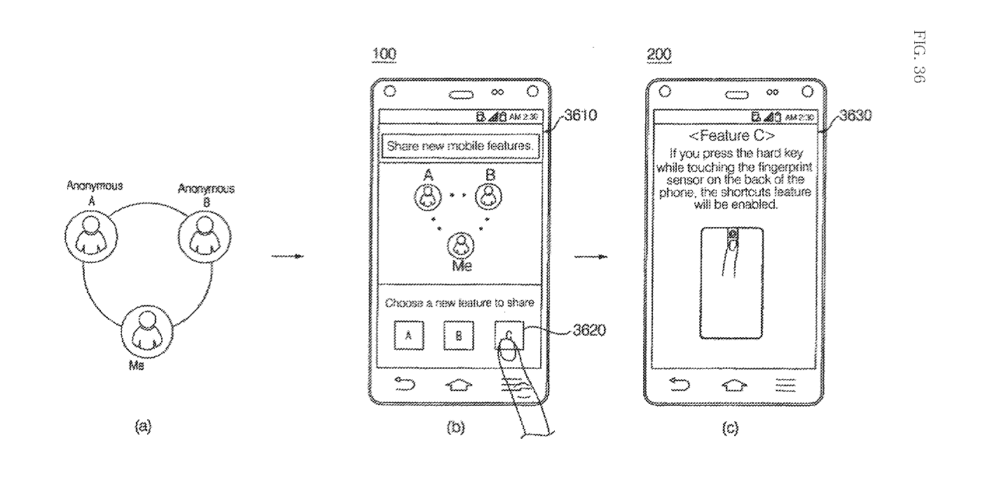

FIG. 36 is a view used as a reference to explain a mobile terminal's operation for sharing a mobile phone's new features with anonymous people by using collective intelligence.

Referring to FIG. 36, the concierge server may share a mobile phone's new features related to group members' interests by using collective intelligence data. In this case, the concierge server may acquire information on the mobile phone's new features by interfacing with a platform or the like that lets users of the same phone model to share information with one another.

The first mobile terminal 100 may display on the display unit 151 a group app screen 3610 containing information related to the mobile phone's new features provided from the concierge server. If a new feature 3620 is selected from the group app screen 3610, the first mobile terminal 100 may share information on the selected new feature with other group members via the concierge server.

The second mobile terminal 200 may display on the display unit 151 a group app screen 3630 containing information on the new feature shared by the user of the first mobile terminal 100. Besides, it will be obvious to those skilled in the art that music, movies. TV information, device information, etc. may be shared too.

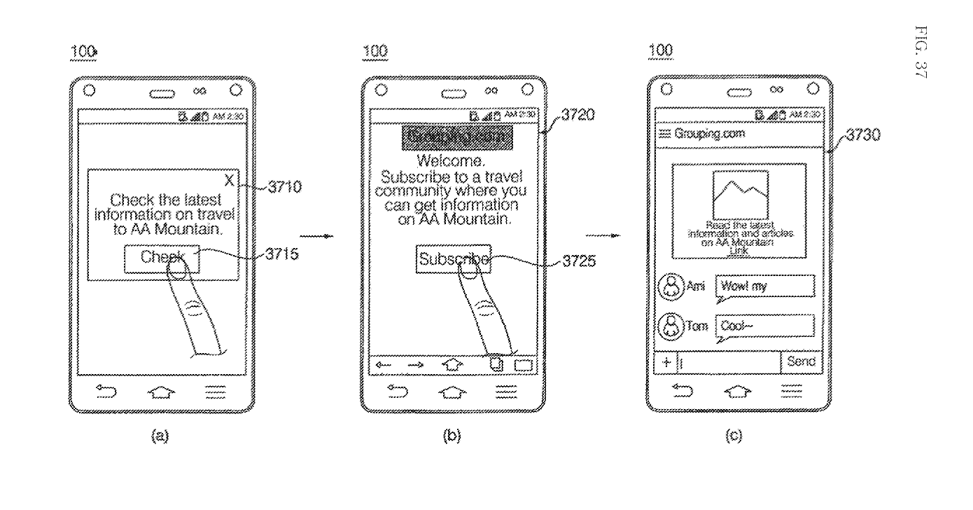

FIG. 37 is a view used as a reference to explain a mobile terminal's operation for sharing travel destination information with anonymous people by using collective intelligence.

Referring to FIG. 37, if the user is interested in travel, the concierge server may let the user to share travel destination information by using collective intelligence data of group members of a group. In this case, the concierge server may acquire travel destination information by interfacing with a platform or the like that lets users of the same phone model to share information with one another.

The mobile terminal 100 may display on the display unit 151 a notification window 3710 containing travel destination information provided from the concierge server. If a OK icon 3715 in the notification window 3710 is selected, the mobile terminal 100 may display on the display unit 151 a group app screen 3720 asking to subscribe to a community related to the travel destination information.

If a subscribe icon 3725 is selected from the group app screen 3720, the mobile terminal 100 may subscribe to a community related to the travel destination information. Accordingly, the mobile terminal 100 may automatically connect to a website related to the community and display on the display unit 151 a website screen 3730 where the user can check travel destination information and chat with other members.

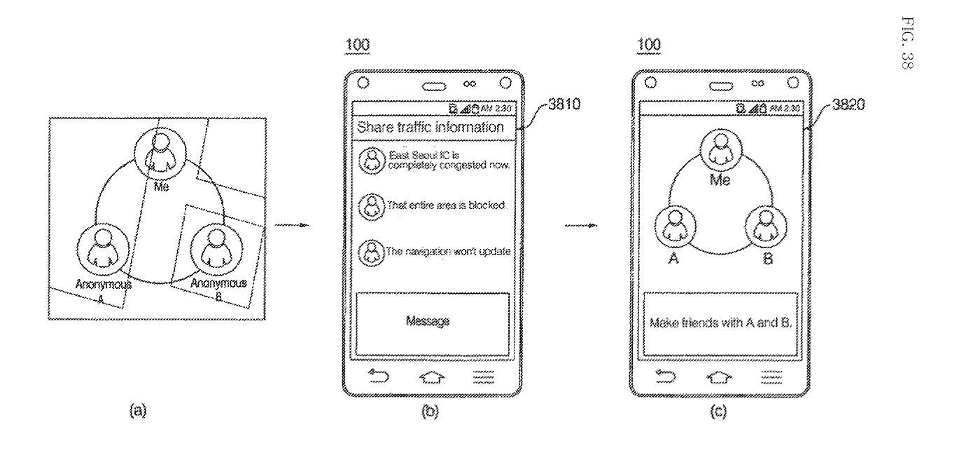

FIG. 38 is a view used as a reference to explain a mobile terminal's operation for sharing weather and traffic information with anonymous people by using collective intelligence.

Referring to FIG. 38, the concierge server may share weather and traffic information with anonymous people by using collective intelligence data. In this case, the concierge server may acquire weather and traffic information by interfacing with a platform or the like that lets users of the same phone model to share information with one another.

The mobile terminal 100 may display on the display unit 151 a group app screen 3810 containing traffic information provided by anonymous people via the concierge server. The user 100 of the mobile terminal may check traffic information for other areas via the group app screen 3810 and share traffic information for their current location with other people via text input.

Meanwhile, the mobile terminal 100 may display on the display unit 151 a group app screen 3820 that finds anonymous people with similar interests to the user's own with whom you can share traffic information and encourages the user to make friends with them.

The present invention may be implemented by a computer readable medium in which a program is recorded. The computer readable medium may include all kinds of recording apparatuses in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, or the like, and may also include a medium implemented in a form of a carrier wave (for example, transmission through the Internet). In addition, the computer may also include the control unit 180 of the terminal. Therefore, the above detailed description is not to be interpreted as being restrictive, but is to be considered as being illustrative. The scope of the present invention is to be determined by reasonable interpretation of the claims, and all alterations within equivalencies of the present invention fall within the scope of the present invention.

1. A method for controlling a mobile terminal, the method comprising the steps of:
sending a request for starting of a group concierge service to a concierge server;
receiving, from the concierge server, information on other terminal users having the same interest as a user of the mobile terminal; and
displaying information which proposes generation of a group with the other terminal users.

2. The method of claim 1, further comprising setting the range of information that can be collected by the concierge server.

3. The method of claim 1, further comprising identifying, by the concierge server, the user's interests by collecting information on the mobile terminal for a certain period of time.

4. The method of claim 1, further comprising detecting, by the concierge server, other terminal users having the same interest as the user by collecting information on other mobile terminals.

5. The method of claim 4, wherein, in the detection step, other terminal users having the same interest as the user are detected from among terminal users acquired from address book information or SNS friend information of the mobile terminal.

6. The method of claim 4, wherein, in the detection step, anonymous people having the same interest as the user are detected by using collective intelligence data.

7. The method of claim 1, further comprising providing information relating to the group's common interests after completion of the group generation.

8. The method of claim 1, further comprising displaying information suggesting other group members' interests after completion of the group generation.

9. The method of claim 1, further comprising displaying information suggesting to share the user's interests with other group members after completion of the group generation.

10. The method of claim 6, further comprising displaying interest information reproduced using collective intelligence of group members after completion of the group generation.

11. A mobile terminal comprising:
a display unit;
a wireless communication unit that performs wireless communication with a concierge server; and
a control unit that, upon a group concierge service request, receives information on other terminal users having the same interest as a user of the mobile terminal from the concierge server and displays on the display unit information proposing generation of a group with the other terminal users.

12. The mobile terminal of claim 11, wherein the control unit sets the range of information that can be collected by the concierge server.

13. The mobile terminal of claim 11, wherein the concierge server identifies the user's interests by collecting information on the mobile terminal for a certain period of time.

14. The mobile terminal of claim 11, wherein the concierge server detects other terminal users having the same interest as the user by collecting information on other mobile terminals.

15. The mobile terminal of claim 14, wherein the concierge server detects other terminal users having the same interest as the user from among terminal users acquired from address book information or SNS friend information of the mobile terminal.

16. The mobile terminal of claim 14, wherein the concierge server detects anonymous people having the same interest as the user by using collective intelligence data.

17. The mobile terminal of claim 11, wherein the control unit provides information relating to the group's common interests after completion of the group generation.

18. The mobile terminal of claim 11, wherein the control unit displays information suggesting other group members' interests after completion of the group generation.

19. The mobile terminal of claim 11, wherein the control unit displays information suggesting to share the user's interests with other group members after completion of the group generation.

20. The mobile terminal of claim 16, wherein the control unit provides interest information reproduced using collective intelligence of group members after completion of the group generation.
